(19) United States
(12) Patent Application Publication
(10) Pub. No.: US 2005/0273423 A1
(43) Pub. Date: Dec. 8, 2005

(54) System, method, and apparatus for a complete mortgage solution for borrowers, mortgage brokers, mortgage bankers, and investors

(76) Inventors: Amir Kiai, Irvine, CA (US); Raja Epsilon, Laguna Niguel, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/140,566

(22) Filed: May 27, 2005

Related U.S. Application Data
(60) Provisional application No. 60/575,130, filed on May 28, 2004.

(51) Int. Cl. G06F 17/60

(52) U.S. Cl. 705/38

(57) ABSTRACT

The system and method provide a complete solution for borrowers, brokers, mortgage bankers, and investors in the mortgage industry. The embodiments provide a centralized Internet system that auctions mortgage loans—a system for auctioning loans in the primary market and another for auctioning loans in the secondary market. There is a third auctioning system for auctioning leads (information about potential borrowers) to brokers. The latter system feeds the primary loan auction system while at the same time increasing a borrower's opportunity to obtain a satisfactory loan package. The primary loan auction system encourages optimum rebate values for brokers, provides an improved opportunity to borrowers to obtain the best loan program with the lowest rate available, and feeds the secondary loan auction system with loan packages. The secondary loan auction system encourages optimum rebate values for mortgage bankers and provides improved opportunities to investors to access a large pool of loans matching their requirements.

### RELATED APPLICATION

This patent application takes priority under 35 U.S.C. § 119(e) to U.S. Patent Application No. 60/575,130, entitled “A SYSTEM, METHOD, AND APPARATUS FOR A COMPLETE MORTGAGE SOLUTION FOR BORROWERS, MORTGAGE BROKERS, MORTGAGE BANKERS, AND INVESTORS”, filed May 28, 2004, which is hereby incorporated by reference.

### BACKGROUND OF THE INVENTION

1. Field of the Invention

The present invention relates generally to a complete mortgage solution for borrowers, brokers, mortgage bankers, and investors and specifically it relates to a lead and two loan auction systems, a primary and a secondary auction system. The invention provides a complete solution for the processing of mortgage loans in both the primary and secondary market of the real estate industry. The major entities involved in such a solution include borrowers, mortgage brokers, mortgage bankers, and investors.

2. Description of the Related Art

It can be appreciated that mortgage loan systems have been in use for years. Typically, in the art of mortgage loans, the borrower borrows money from a mortgage banker (lender) through a mortgage broker. Loans can be for refinancing an existing property or the purchase of a new property. For purchase, Agents (buyer agent/listing agent) interact with property buyers and sellers. A buyer agent assists the homebuyer in finding the right property. A listing agent works with the property seller to sell the property at the right price. Other parties involved in a mortgage loan are the Title Company, Appraiser, and Escrow. The Title Company provides insurance policies, such as the standard ALTA (American Land Title Association) policy, which protects the buyer of the property from fraudulent titles. The Appraiser determines the market value of the property by appraising it based on either the cost approach or comparable sales approach, by researching sales in the past few months, typically three or twelve months. An Escrow party acts as a mediator agent to guarantee distribution of funds to all parties involved in the Escrow “Statement of fees.” The Escrow party may also monitor the future revolving or installment payments made to Tax, Insurance or other agencies. The involvement of these parties in the mortgage loan industry, in addition to buyers, sellers, mortgage bankers, and investors, results in a high volume of paper documents, often transferred among them and manually processed.

The process of a borrower looking for a loan through a mortgage broker typically starts with an interview of the borrower by the broker. The broker, through the interview with the borrower, collects information from the borrower and completes the loan application forms for the mortgage banker to qualify the borrower for a loan. The broker then sets out to put together a loan package for the borrower. The loan package includes documents such as loan application forms, a credit report, an appraisal report, a title report, credit disclosures, bank statements, verification of employment, and verification of deposits. To complete a loan package, the broker (typically a mortgage loan processor) opens up a dialogue with various entities (Escrow, Agents, Title Company, Appraiser etc.). This can be a lengthy process and often the broker adopts a shortcut approach, pre-qualifying the borrower by submitting limited information. However, in the end, the mortgage banker always requires the loan package to satisfy all criteria and stipulations in order to fund the loan. Typically, the broker has established contracts, with an appraiser, title company, etc., which may not offer the best price for the borrower. Competition among the entities would lower costs for the borrower. Typically, the broker submits multiple applications to multiple mortgage bankers in order to provide a competitive loan program to the borrower. Depending on the condition of the loan package, the mortgage banker can either fund the loan or put conditions and ask for more documents from the broker to make the loan package complete and fit for funding. After all conditions are met the mortgage banker proceeds to fund the loan.

Loans serviced by the mortgage banker itself are called portfolio loans and this is the primary market. The primary market allows mortgage bankers to generate a profit when they fund the loans. The profit margin in this primary market is called “rebate”. The unit for this rebate is on a percentage point system from the total loan amount. Typically, the rebate is in the range of 0.125% to 5.000% of the funded loan amount. It is also possible that a mortgage banker will sell a loan to investors, in which case the borrower's trust deed is transferred and serviced by the investors. Mortgage bankers use their warehouse line of credit to sell these already funded loans to investors. Often a mortgage banker will sell a pool of loans to an investor rather than single loans. This informal market, where mortgage bankers and investors sell and buy existing mortgages, is the Secondary Market. Selling already funded loans in the Secondary market allows mortgage bankers to increase their profit margin. This profit margin in the secondary market is called the mortgage banker rebate. The unit for this rebate is on a percentage point system from the total funded loan amount. Typically, this rebate is two to three times the primary market profit margin or rebate.

This whole process—starting from a borrower initiating the first dialogue with a broker to the mortgage banker funding the loan in the primary market and an investor purchasing an already funded loan in the secondary market—involves a series of tedious steps. Each step involves numerous documents traveling between all these entities playing their respective role in the mortgage industry. Adding to the complexity, these processes are frequently not strictly sequential. For instance, for a purchase the process of a borrower deciding on a property through Agents and the process of a borrower talking to a broker about a loan can happen concurrently. These processes in the traditional mortgage industry are often accomplished manually using hard-copy paper documents. The dynamics involved with these processes adds to the complexity of processing mortgage loans.

A major challenge that brokers often face in the mortgage industry is having limited exposure to mortgage bankers. Typically, a broker has relationships with only a few mortgage bankers. This often results in a broker not being able to find a suitable loan program for the borrower, especially sub-prime borrowers. Thus, conventional mortgage loan systems do not always provide a cost effective and competitive marketplace for the broker. The relationship between brokers and mortgage bankers is a two-way relationship. Mortgage bankers obtain loan submissions from a list of brokers with whom they usually work. Often many of the loan applications submitted to them do not qualify for their loan programs. The lack of exposure to brokers limits the number of loan programs mortgage bankers may sell. Thus, getting loan submissions from a larger number of brokers will provide mortgage bankers with a better opportunity to sell more loan programs. Another issue, already mentioned, is the slow-down in the mortgage process resulting from the manual processing of large volumes of paper work which are transported from one organization to another. These issues of limited exposure and slow, tedious, manual processing also apply to the secondary market. Moreover, the processing of a loan in the secondary market is even slower as it involves even more paperwork and the copying of previously generated documents. It also involves the tedious task of tracking these funded loan packages to sell in pools to investors. In other words, the current mortgage industry lacks a single tool that serves the purposes of expediting the processing of loan packages as well as providing better opportunities for competitive loan programs to fall four major parties (borrowers, brokers, mortgage bankers, and investors) involved in the mortgage loan process.

### SUMMARY

In view of disadvantages inherent in the known types of mortgage loan systems now present in the prior art, the present system and method provides a new, complete mortgage solution for borrowers, brokers, mortgage bankers, and investors. This substantially departs from the conventional concepts and designs of the current mortgage industry model, and in doing so, provides an alternative system primarily developed for providing a tool to expedite the loan process and serve the interests of borrowers, brokers, mortgage bankers, and investors. The scope of this system and method includes both the primary and secondary markets of the mortgage industry. Both residential and commercial properties are within the scope of this system and method. This system and method provides many novel features that are not anticipated, rendered obvious, suggested, or even implied by any of the prior art mortgage systems, either alone or in combination.

In one embodiment, there is an electronic marketplace method for loans, the method comprising receiving, via an electronic interface, mortgage loan information, the loan information comprising social security information; retrieving credit information using, at least in part, the social security information; generating a credit score based upon the retrieved credit information; transmitting, via an electronic interface, the generated credit score to a plurality of brokers; auctioning to the brokers, via an electronic interface, access to the received mortgage loan information; wherein the auctioning to the brokers comprises setting an initial value for a broker bid and a bid increment; automatically receiving bids from the plurality of brokers; and automatically determining one of the bids based upon auction criteria and the broker bid value; setting an initial value for a service provider bid item based on, at least in part, the loan information; receiving bids from a plurality of service providers in conjunction with a loan; automatically determining one of the service provider bids based upon auction criteria and the service provider bid item; identifying at least one borrowing criteria based on an underwritable loan package; automatically receiving bids from a plurality of mortgage bankers; automatically determining one of the bids based upon auction criteria and the borrowing criteria; receiving one or more secondary underwritten loan packages associated with a banker, the secondary loan packages identifying a secondary loan bid item; setting an initial value for the secondary loan bid item based on the secondary loan packages; automatically receiving bids from a plurality of investors; and automatically determining one of the investor bids based upon auction criteria and the secondary loan bid item.

The auctioning may comprise auctioning access to the mortgage loan information of one prospective borrower. The auction criteria may comprise improving on a valid bid. The auction criteria may comprise a bid received before an auction end time. The service provider bid item may comprise an appraisal and an associated cost of the appraisal, a homeowners insurance policy and an associated cost of the insurance policy, a title policy and an associated cost of the title policy, and/or notary service and an associated cost of the notary service. The borrowing criteria may comprise a predetermined minimum number of criteria. The borrowing criteria may be entered by the borrower or a broker for the borrower. The mortgage bankers may not have access to selected personal information about the borrower until reaching a bidding level. The borrowing criteria may comprise a desired interest rate for the loan, a prepayment penalty term for the loan, a desired closing cost percentage for the loan, a loan program period for the loan, a desired loan term for the loan, and/or a desired broker rebate for the loan. The secondary loan bid item may comprise a banker rebate and a value of the rebate.

In another embodiment, there is an apparatus for facilitating issuance of mortgage loans, comprising the computer implemented acts of storing a plurality of bid items; comparing the stored bid items with bids received from mortgage bankers; automatically determining one of the bids based upon auction criteria and the bid items, wherein the auction criteria comprise improving on a valid bid, wherein the valid bid improves on a predetermined number of bid items of a last valid bid by at least a guideline value, and wherein the auction criteria comprise a lack of banker conditions for the loan; receiving one or more secondary underwritten loan packages associated with a banker, the secondary underwritten loan packages identifying a secondary loan bid item; storing an initial value for the secondary loan bid item based on the secondary underwritten loan packages; comparing the stored secondary loan bid item value with bids received from investors; and automatically determining one of the bids based upon secondary loan auction criteria and the secondary loan bid item, wherein the secondary loan auction criteria comprise improving on a valid bid, wherein the valid bid improves on a last valid bid by at least a guideline value, and wherein the secondary loan auction criteria comprise a lack of investor conditions for the loan. The secondary loan bid item may comprise a banker rebate and a value of the rebate. The auction criteria may comprise a valid bid received before an auction end time.

In another embodiment, there is in an apparatus for facilitating issuance of mortgage loans, comprising the computer implemented acts of storing a plurality of bid items; comparing the stored bid items with bids received from mortgage bankers; and automatically determining one of the bids based upon auction criteria and the bid items, wherein the auction criteria comprise improving on a valid bid, wherein the valid bid improves on a predetermined number of bid items of a last valid bid by at least a guideline value, and wherein the auction criteria comprise a lack of banker conditions for the loan.

In another embodiment, there is a computerized method comprising receiving, via an electronic interface, mortgage loan information about a plurality of prospective borrowers, the loan information comprising social security information; retrieving credit information using, at least in part, the social security information; generating a credit score based upon the retrieved credit information; transmitting, via an electronic interface, the generated credit score to a plurality of bidders; and auctioning to the bidders, via an electronic interface, access to the received mortgage loan information.

The auctioning may comprise auctioning access to the mortgage loan information of one prospective borrower, and the bidders may comprise brokers. The method may additionally comprise receiving, via an electronic interface, mortgage loan information about a plurality of prospective borrowers, the loan information without social security information; and selling, via an electronic interface, access to the received mortgage loan information without the social security information. The selling may comprise bundling mortgage loan information from a plurality of prospective borrowers for sale to a broker.

In another embodiment, there is a computerized method comprising receiving, via an electronic interface, mortgage loan information from a plurality of prospective borrowers; selecting mortgage loan information not having social security information; and selling, via an electronic interface, access to the selected mortgage loan information.

In another embodiment, there is a computerized method comprising receiving an underwritable loan package, the underwritable loan package identifying at least one borrowing criteria; automatically receiving bids from a plurality of mortgage bankers; and automatically determining one of the bids based upon auction criteria and the borrowing criteria. The borrowing criteria may comprise a predetermined minimum number of criteria. The borrowing criteria may be entered by the borrower or a broker for the borrower. The mortgage bankers may not have access to selected personal information about the borrower until reaching a bidding level. The mortgage bankers place a bid upon accessing a complete underwritable loan package of the borrower. The mortgage bankers may place a bid with either certain documentation or funding conditions or with no conditions. The auction criteria may comprise a timeframe for accepting bids. The auction criteria may comprise a bid without documentation or funding conditions. The auction criteria may further comprise a bid received before an auction end time. The borrowing criteria may comprise a desired interest rate for the loan, a prepayment penalty term for the loan, a desired closing cost percentage for the loan, a loan program period for the loan, a desired loan term for the loan, and/or a desired broker rebate for the loan.

In another embodiment, there is a computerized system comprising means for receiving an underwritable loan package, the underwritable loan package identifying at least one borrowing criteria; means for automatically receiving bids from a plurality of mortgage bankers; and means for automatically determining one of the bids based upon auction criteria and the borrowing criteria.

In another embodiment, there is a computer readable medium containing software that, when executed, causes the computer to perform the acts of receiving an underwritable loan package, the underwritable loan package identifying at least one borrowing criteria; automatically receiving bids from a plurality of mortgage bankers; and automatically determining one of the bids based upon auction criteria and the borrowing criteria.

In another embodiment, there is a computerized method comprising receiving an underwritable loan package, the underwritable loan package identifying at least one borrowing criteria; automatically receiving bids from a plurality of mortgage bankers; and automatically determining one of the bids based upon auction criteria and the borrowing criteria, wherein the bids include certain documentation or funding conditions or no banker conditions.

The method may further comprise treating a bid with documentation or funding conditions as an inactive bid. The method may further comprise treating a bid with no conditions as an active bid. The auction criteria for selecting a bid may comprise a bid status being active.

In another embodiment, there is a method comprising receiving loan information about a borrower, the loan information including at least a unique identifier corresponding to the borrower; setting an initial value for a bid and a bid increment; automatically receiving bids from a plurality of mortgage brokers; and automatically determining one of the bids based upon auction criteria and the bid value.

The auction criteria may comprise improving on a valid bid. A valid bid may improve on a last valid bid by at least the bid increment. The auction criteria may comprise a bid received before an auction end time. The auction criteria may comprise a valid bid received before an auction end time. The unique identifier corresponding to the borrower may comprise a social security number. The unique identifier corresponding to the borrower may comprise a nationally recognized identification number.

In another embodiment, there is a method comprising receiving an underwritable loan package, the underwritable loan package identifying at least one bid item; setting an initial value for each bid item based on the underwritable loan package; automatically receiving bids from a plurality of mortgage bankers; and automatically determining one of the bids based upon auction criteria and the bid items.

The underwritable loan package may be received from a broker. The bid items may comprise a predetermined minimum number of items. The bid items may be entered by the borrower or a broker for the borrower. The bid items may be entered by the borrower and a broker for the borrower collaborating together. The bid items may comprise an item type and an item value. The auction criteria may comprise improving on a valid bid. The valid bid may improve on at least one bid item of a last valid bid by at least a guideline value. The auction criteria may comprise improving on a valid bid for a predetermined number of bid items. The auction criteria may comprise a lack of banker conditions for the loan. The auction criteria may comprise one or more banker documentation or funding conditions for the loan that are met by the borrower or a broker for the borrower. The auction criteria may comprise a bid received before an auction end time. The auction criteria may comprise a valid bid with a lack of banker conditions for the loan, the bid received before an auction end time.

In another embodiment, there is a computerized system comprising means for receiving an underwritable loan package, the underwritable loan package identifying at least one bid item; means for setting an initial value for each bid item based on the underwritable loan package; means for automatically receiving bids from a plurality of mortgage bankers; and means for automatically determining one of the bids based upon auction criteria and the bid items.

In another embodiment, there is a computer readable medium containing software that, when executed, causes the computer to perform the acts of receiving an underwritable loan package, the underwritable loan package identifying at least one bid item; setting an initial value for each bid item based on the underwritable loan package; automatically receiving bids from a plurality of mortgage bankers; and automatically determining one of the bids based upon auction criteria and the bid items.

In another embodiment, there is a computerized method comprising receiving one or more secondary underwritten loan packages associated with a banker, the secondary underwritten loan packages identifying a bid item; setting an initial value for the bid item based on the secondary underwritten loan packages; automatically receiving bids from a plurality of investors; and automatically determining one of the bids based upon auction criteria and the bid item.

The bid item may comprise a banker rebate and a value of the rebate. The auction criteria may comprise improving on a valid bid. A valid bid may improve on a last valid bid by at least a guideline value. The auction criteria may comprise a lack of investor conditions for the loan. The auction criteria may comprise one or more investor documentation or funding conditions for the loan that are met by the banker. The auction criteria may comprise a bid received before an auction end time. The auction criteria may comprise a valid bid with a lack of investor conditions for the loan, the bid received before an auction end time.

In another embodiment, there is a computerized system comprising means for receiving one or more secondary underwritten loan packages associated with a banker, the secondary underwritten loan packages identifying a bid item; means for setting an initial value for the bid item based on the secondary underwritten loan packages; means for automatically receiving bids from a plurality of investors; and means for automatically determining one of the bids based upon auction criteria and the bid item.

In another embodiment, there is a computer readable medium containing software that, when executed, causes the computer to perform the acts of receiving one or more secondary underwritten loan packages associated with a banker, the secondary underwritten loan packages identifying a bid item; setting an initial value for the bid item based on the secondary underwritten loan packages; automatically receiving bids from a plurality of investors; and automatically determining one of the bids based upon auction criteria and the bid item.

In another embodiment, there is a method comprising receiving loan information about a borrower; setting an initial value for a bid item based on, at least in part, the loan information; automatically receiving bids from a plurality of service providers in conjunction with a loan; and automatically determining one of the bids based upon auction criteria and the bid item.

The bid item may comprise an appraisal and an associated cost of the appraisal. The bid item may comprise a homeowners insurance policy and an associated cost of the insurance policy. The homeowners insurance policy may comprise a homeowners association policy or a hazard policy. The bid item may comprise a title policy and an associated cost of the title policy. The bid item may comprise notary service and an associated cost of the notary service. The auction criteria may comprise improving on a valid bid. A valid bid may improve on a last valid bid by at least a decrement value. The auction criteria may comprise a lack of provider conditions for the loan. The auction criteria may comprise one or more provider conditions for the service that are met by the borrower or a broker for the borrower. The auction criteria may comprise a bid received before an auction end time. The auction criteria may comprise a valid bid with a lack of provider conditions for the loan, the bid received before an auction end time.

In yet another embodiment, there is a computerized method comprising electronically tracking a receipt of each of a plurality of documents in an underwritable loan package in preparation of an electronic auction; and electronically displaying a status to a broker, the status identifying which of the plurality of documents have been received and which of the documents are missing from the loan package.

The method may additionally comprise receiving a scanned image of at least one of the plurality of documents. The method may additionally comprise receiving a facsimile of at least one of the plurality of documents. The method may additionally comprise physically receiving at least one of the plurality of documents. The status for each of the plurality of documents may comprise complete, in process, or pending. The method may additionally comprise displaying the plurality of documents via a network browser. The plurality of documents may comprise a 1003 loan application, a 1008 summary of loan application, and a credit report.

### BRIEF DESCRIPTION OF THE DRAWINGS

FIG. 1 is a block diagram of an exemplary configuration of system components of an embodiment of the invention.

FIG. 2 is a block diagram of an embodiment of the lead auction engine shown in FIG. 1.

FIG. 3 is a block diagram of an embodiment of the primary loan uploader engine interacting with portions of the primary loan auction engine shown in FIG. 1.

FIG. 4 is a block diagram of an embodiment of the primary loan auction engine shown in FIG. 1.

FIG. 5 is a block diagram of an embodiment of the secondary loan uploader engine interacting with portions of the secondary loan auction engine shown in FIG. 1.

FIG. 6 is a block diagram of an embodiment of the secondary loan auction engine shown in FIG. 1.

FIG. 7 is a flow diagram of an exemplary top-level process of an embodiment of the invention operable on the system shown in FIG. 1.

FIGS. 8A and 8B is a flow diagram of an embodiment of the lead creation process shown in FIG. 7.

FIG. 9 is a flow diagram of an embodiment of the lead auction process shown in FIG. 7.

FIG. 10 is a flow diagram of an embodiment of the primary loan creation process shown in FIG. 7.

FIG. 11 is a flow diagram of an embodiment of the primary loan auction process shown in FIG. 7.

FIG. 12 is a flow diagram of an embodiment of the primary loan sub-auction process for an appraisal shown in FIG. 7.

FIG. 13 is a flow diagram of an embodiment of the primary loan sub-auction process for a hazard insurance policy shown in FIG. 7.

FIG. 14 is a flow diagram of an embodiment of the primary loan sub-auction process for a title shown in FIG. 7.

FIG. 15 is a flow diagram of an embodiment of the primary loan sub-auction process for a notary shown in FIG. 7.

FIG. 16 is a flow diagram of an embodiment of the secondary loan creation process shown in FIG. 7.

FIG. 17 is a flow diagram of an embodiment of the secondary loan auction process shown in FIG. 7.

FIGS. 18A and 18B are a diagram of an exemplary configuration of the sub-auction engines in embodiments of the invention.

### DETAILED DESCRIPTION OF CERTAIN EMBODIMENTS

Before explaining the embodiments of the system and method in detail, it is to be understood that the embodiments are not limited in its application to the details of implementation and to the arrangements of the components set forth in the following description or illustrated in the drawings. The embodiments of the system and method can be practiced and carried out in various ways. In addition, it is to be understood that the phraseology and terminology employed herein are for the purpose of the description and should not be regarded as limiting.

A network as referred to herein may refer to a network or combination of networks spanning any geographical area, such as a local area network, wide area network, regional network, national network, and/or global network. The Internet is an example of a current global computer network. Those terms may refer to hardwire networks, wireless networks, or a combination of hardwire and wireless networks. Hardwire networks may include, for example, fiber optic lines, cable lines, ISDN lines, copper lines, etc. Wireless networks may include, for example, cellular systems, personal communications service (PCS) systems, satellite communication systems, packet radio systems, and mobile broadband systems. A cellular system may use, for example, code division multiple access (CDMA), time division multiple access (TDMA), personal digital phone (PDC), Global System Mobile (GSM), or frequency division multiple access (FDMA), among others. The network may be any type of electronic transmission medium or environment where information can be sent, shared with, passed on or bypassed among two or more computer systems linked or wired together and to other digital devices by telephone (landline), wireless, Internet (voice and data), Worldwide Web (online), video, including related or derivative networks (such as in-flight wireless LAN data networks, wireless email networks, Bluetooth) and the interconnection between different network types, such as home-area networks (HANs), local-area networks (LANs), and interconnections of LANs, such as campus-area network (CANs), metropolitan-area networks (MANs), private-area networks (PANs or piconets), and wide-area networks (WANs). The network could also include, but is not limited to a virtual private network, a public Internet, a private Internet, a secure Internet, a private network, a public network, a value-added network, an intranet, or a wireless gateway. The term “virtual private network” refers to a secure and encrypted communications link between nodes on the Internet, a Wide Area Network (WAN), Intranet, or any other network transmission means. In addition, the connectivity to the network may be via, for example, a modem, Ethernet (IEEE 802.3), Token Ring (IEEE 802.5), Fiber Distributed Datalink Interface (FDDI), Asynchronous Transfer Mode (ATM), Wireless Application Protocol (WAP), or other form of network connectivity.

The system and method provides an online mortgage marketplace for the sale and purchase of mortgage loans over a network such as over the Internet using a web browser. The system includes three auction engines, the Lead Auction Engine, the Primary Loan Auction Engine, and the Secondary Loan Auction Engine. Each of these engines is comprised of components that implement this functionality. These components are outlined and described below with accompanying figures for better understanding.

The system further includes four sub-auction engines; a Primary Loan Sub-Auction Engine for Appraisal, a Primary Loan Sub-Auction Engine for Homeowner Insurance Policy, a Primary Loan Sub-Auction Engine for Title, and a Primary Loan Sub-Auction Engine for Notary. These engines facilitate bidding by third party service providers so as to reduce costs for the borrower. The processing performed for the primary loan sub-auctions will be described herein below.

The general purpose of the system and method, which will be described subsequently in detail, is to provide a centralized system that provides a platform to accommodate most of the processes involved with mortgage loans. Each entity (borrower, broker, mortgage banker, investor, Title Company, Escrow, Appraiser, Agent, etc.) plays its part in such a system. A centralized location for the processing of loan data expedites loan processing. Borrowers, real estate brokers, mortgage bankers, and investors play their respective roles from their desktops using an Internet browser. Other entities such as Appraisers, Title Companies, Escrows, and Agents contribute their part in real time to help further the processing of the loans. This centralized system eliminates the need for all parties to re-key data into their own separate systems, thereby saving valuable time and resources. In particular, embodiments of the system and method, which are referred to as the electronic bidding system, the overall system, or the system in the rest of the document, consists of five engines—the Lead Auction Engine (auctions the leads among brokers), the Primary Loan Uploader Engine (enables brokers and borrowers to put together an underwritable primary loan package for mortgage bankers), the Primary Loan Auction Engine (auctions primary loans in the primary market among mortgage bankers), the Secondary Loan Uploader Engine (enables mortgage bankers and Title/Escrow/Agents, to put together a secondary loan package for an investor in the secondary market), and the Secondary Loan Auction Engine (auctions previously funded loans among investors in the secondary market). In addition, there are three major interfaces providing access to the system for the various involved parties. They are the Lead Web Interface (providing access to borrowers and brokers), the Primary Web Interface (providing access to borrowers, brokers, mortgage bankers, and various third parties such as Escrow, Agents, and Appraiser), and the Secondary Web Interface (providing access to Mortgage Bankers, investors, and various third parties including Escrow, Agents, and Appraiser). Hereafter, loans in the primary market will be referred to as “primary” loans and loans in the secondary market will be referred to as “secondary” loans. The system also includes the four primary loan sub-auction engines previously mentioned. In certain embodiments, while the Primary Loan Uploader Engine is used to put together the underwritable loan package, the sub-auction engines for appraisal, homeowners insurance policy and title operate to receive bids from the third party service providers. In certain embodiments, the sub-auction for notary is performed after the primary loan auction completes. The data for the sub-auctions is provided by the broker, in certain embodiments.

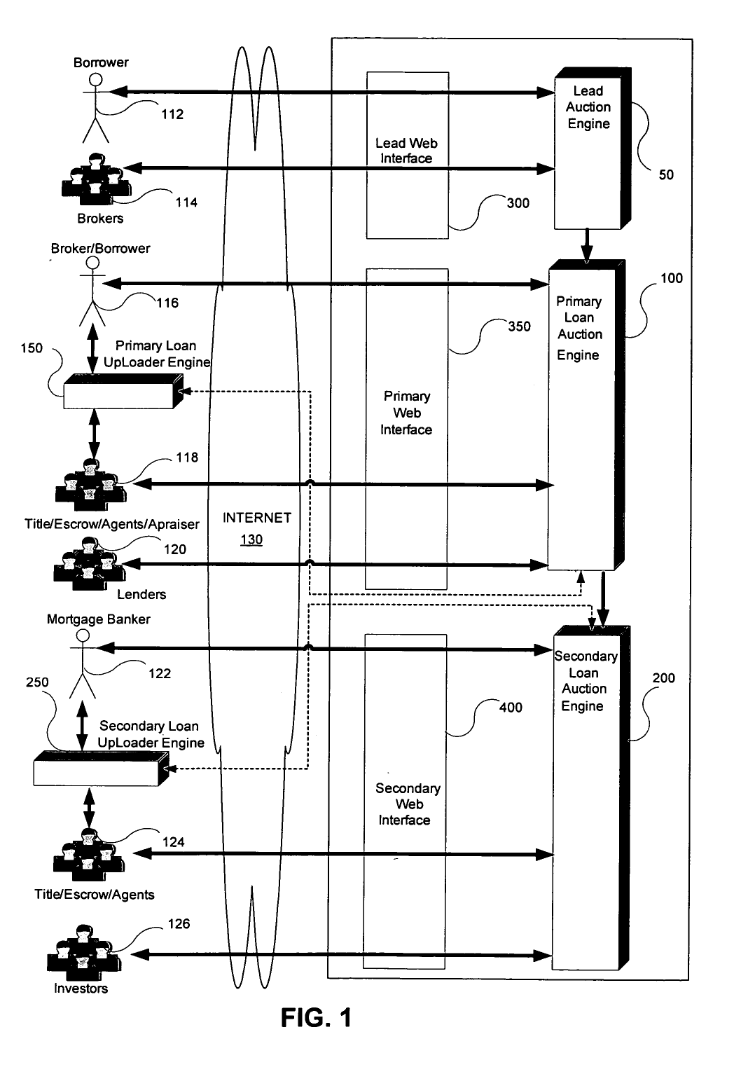

To better illustrate the embodiment, FIG. 1 displays the five engines (labeled 50, 100, 150, 200, and 250), the three interfaces (labeled 300, 350, and 400), and their respective roles in the context of the mortgage loan process. (Note that these number labels are consistent among all figures included in this document.) Interactions between components and actors/people are illustrated using bold two-way arrows, with the exception of the dotted arrows associated with the Primary and Secondary Loan Uploader Engines. The dotted lines are used to indicate that these latter two components, though communicating using an Internet 130, will not rely on a web browser to do so. In other embodiments, other types of networks can be used. Components 50, 100, and 200 are auction engines and components 150 and 250 provide the data to the auction engines they require to fulfill their functions. Borrowers 112 provide their information to qualify as a lead using a web browser. The Lead Auction Engine (50) processes the information and auctions the lead among multiple brokers. Brokers 114 bid for the lead and the winning broker is provided with the information to contact the borrower. At this point, the lead data is transferred from the Lead Auction Engine to the Primary Loan Auction Engine (100) as a loan application. The winning broker and the borrower 116 work to complete the loan application which, in turn, may require the contribution of third parties including Escrow, Title Company, Agents, and Appraiser 118. The process of putting together the underwritable loan package may or may not require the Primary Web Interface (350). The Primary Loan Uploader Engine (150) communicates with the Primary Loan Auction Engine without the use of a web browser. Details of this will be provided later in this document. The Primary Loan Auction Engine (100) processes the underwritable loan package and, once it is complete, commences an auction of the loan package among lenders 122 or mortgage bankers. While the underwritable primary loan package is being prepared, three sub-auctions can be processed. Once the primary loan auction is complete, the fourth sub-auction for notary can be completed. The lenders or mortgage bankers bid and the highest bidder wins the primary loan package. At this stage, the mortgage banker may or may not service the loan; many mortgage bankers 122 do service the loan but many use their warehouse to sell the loans to investors 126 in the secondary market. In the event they decide to do the latter, the system obtains relevant data from the Primary Loan Auction Engine and allow the mortgage banker 122 to auction the underwritten secondary loan package among investors 126.

The embodiments provide a complete mortgage solution for borrowers, brokers, mortgage bankers, and investors that overcomes the shortcomings of prior art systems. The embodiments, through the primary and secondary loan auction systems, ensure that borrowers get the best offer from mortgage bankers and mortgage bankers the best offer from investors. Such outcomes heighten a borrower's confidence in the system and as a result brokers, mortgage bankers, and investors benefit from an increasing volume of underwritable loan packages flowing through the system. (Note that the embodiments do not always require borrowers to auction the lead before auctioning the loan package. Borrowers may bypass the Lead auction, contact a Broker outside the scope of the system, and still be able to use the system to auction the loan to get the best value for the loan package.) A substantial part of the underwritable primary loan package that a mortgage banker wins through the Primary Loan Auction Engine can be used to complete the secondary loan package, saving a lot of manual work and helping in tracking and bundling funded loan packages. Additionally, the embodiments provide both mortgage bankers and investors more exposure to each other for a greater volume of loans. Embodiments of the system and method may be in the form illustrated in the accompanying drawings, attention being called to the fact, however, that the drawings are illustrative only, and that changes may be made in the specific construction illustrated.

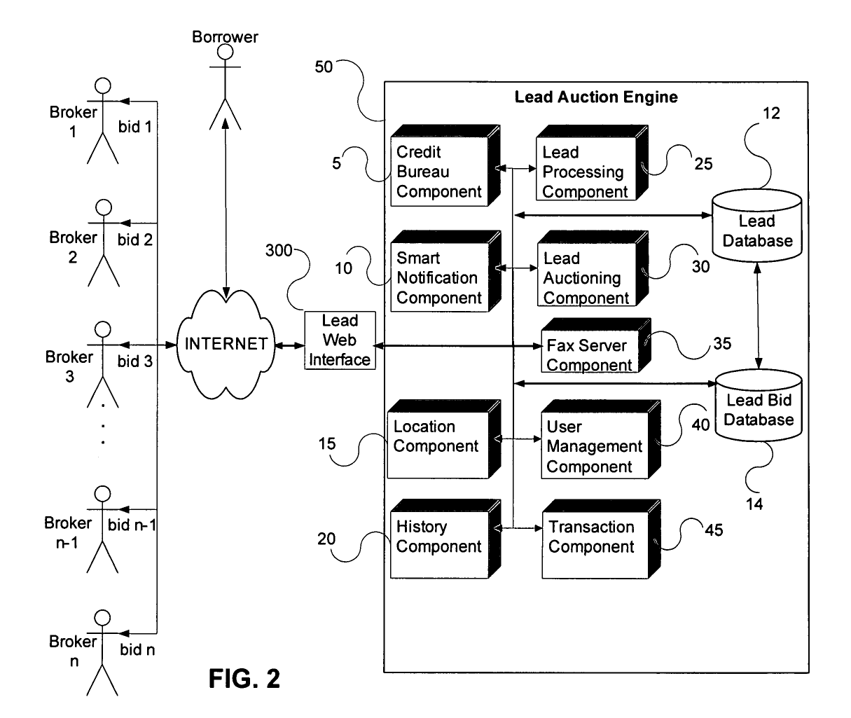

FIG. 2 displays the components comprising the Lead Auction Engine. The major components of the Lead Auction Engine are Credit Bureau Component (5), Smart Notification Component (10), Lead Database (12), Lead Bid Database (14), Location Component (15), History Component (20), Lead Processing Component (25), Lead Auctioning Component (30), Fax Server Component (35), User Management Component (40), and Transaction Component (45).

The User Management Component (40) regulates access to the system, including registration with the system, and maintains configuration settings for individual user logins during the use of the system. As the User Management Component (40) allows access to the system for the various users, various interfaces are included for each type of user, wherein different types of information are collected. For example, a borrower may enter user information, including, but not limited to, name, address, desired loan amount, Social Security Number (SSN), gross income and desired loan terms. Similarly, in addition to standard identifying information (name, company), a broker must register with the system by providing several important pieces of information including the broker's license number, and further, could input desired notification methods and relevant associated notification information (for example, email address, fax number, and telephone number). Additionally, the lender has an interface to allow for lender registration with the system, and to further input relevant information, including, but not limited to, lender license information, year established and size of business. Finally, investors (discussed later) also have an interface for inputting investor information, including, but not limited to, name, desired notification methods and relevant associated notification information (for example, email address, fax number, and telephone number), and information pertaining to qualifications for desired loan purchases.

Additionally, the User Management Component controls the type of access provided to the system's three web interfaces (300, 350, and 400). For example, not all registered brokers are allowed access through the Lead Web Interface (300) to participate in a lead auction; among registered brokers, only selected qualified brokers are allowed to use the Lead Web Interface to participate in a Lead Auction. (These selected brokers are called Member-Plus brokers. There may be several types of criteria for qualifying as a Member-Plus broker. For example, one criterion may require paying an additional amount periodically to maintain this extra privilege.) In summary, the User Management Component controls who can access the system, which interface the user is presented with, and what features a user could access.

The Credit Bureau Component (5) plays an important role in the Lead Auction Engine. In order to qualify as a lead, borrowers must provide their SSN along with other personal information. The Credit Bureau Component takes that information and processes the credit report and credit score (such as a FICO score) to determine the credit worthiness of the borrower for a mortgage loan. Negative, as well as positive, items in the credit report are highlighted in order to help a broker determine the value of the lead. The system categorizes leads into categories. A borrower providing a SSN is called a “hot” lead and a borrower not providing a SSN is called a “warm” lead. Unlike hot leads, warm leads are not auctioned in the Lead Auction Engine. Warm leads could be sold in bulk to brokers who may then be required to follow up on these leads and, should the purchasing broker and borrower decide to work together, the system may require that the primary loan package be auctioned using the Primary Loan Auction Engine.

The Lead Processing Component (25) is responsible for putting together all relevant information relating to a lead, including the borrower's SSN and credit report. In addition to personal information, this component records a wish list from the borrower for the mortgage loan. The wish list can include items (also referred to as bid items) such as the range of minimum and maximum loan to value (LTV), the range of minimum and maximum interest rate, and the amount of the loan desired. This component relies on the Credit Bureau Component to classify the leads into various categories respecting their credit worthiness and representing their value to brokers. This classification is based on standard mortgage industrial rules for evaluating credit reports. Another relevant category for classifying leads is the geographical location of the lead. Among others, these categories help a broker to evaluate a lead and make the auction realistic and practical. Once the lead is processed and ready to be auctioned off, this component sends the lead data to the Lead Auctioning Component (30) triggering an event to the Smart Notification Component (10).

The Smart Notification Component (10) is configured to notify Member-Plus Brokers (see above) about important system events, such as the start of an auction of new hot leads and the outcome of an auction. Based on user settings regarding notification methods, this component triggers an event to notify the broker, using multiple means including email, fax, phone, and PDA/smart mobile devices. This component provides access to the Lead Auction Engine via a mini-browser in smart mobile devices such as smart-phones and PDA devices.

The Fax Server Component (35) is responsible for faxing documents from the system to other organizations. For example, when the lead auction component starts an auction, brokers with settings requesting notification by fax are sent a fax using this component.

The Location Component (15) is responsible for filtering data based on geographic location. For example, if the broker uses configuration settings to indicate that the system should provide notification only when leads from certain geographic locations are on auction, then this component filters leads to enable this functionality.

The Lead Auctioning Component (30) is responsible for processing the auction of leads in the system. This component receives the lead data from the Lead Processing Component 25. This component may hide certain borrower information (for example a borrower's name, SSN, and full mailing address) for privacy reasons and only display data relevant to indicate the value of the lead to the brokers. Once the auction starts, this component accepts dollar amount bids from different brokers, starting with a minimum bid amount. As in other auctions, certain rules or auction criteria are followed in the auction. In certain embodiments, the auction criteria include requirements for a valid bid, an active bid, and/or a timeframe for bidding. In the Lead Auction, a valid bid must be for a higher amount than the current highest valid bid. The lead is auctioned for a specified period of time. When the auction closes, the highest bidder becomes the winner. The winning broker is provided with complete information about the lead. This component may also allow variations to normal bidding. For example, proxy bidding or “buy it now” can be allowed. Proxy bidding means that the broker can register the maximum it is willing to pay. The lead auction component confidentially bids up to this maximum amount. This frees the broker from having to monitor the auction as it unfolds. If other bidders outbid this maximum by the end of the auction, the proxy-bidding broker will not win the lead. Otherwise, the broker is the winner. (Note, organizations that are both brokers and mortgage bankers are allowed to participate in a lead auction. However, these mortgage bankers/brokers are required to work with borrowers and submit the leads into the primary loan auction system.)

Once the bidding is final and the auction complete, the Transaction Component (45) records the event for accounting and business purposes. This component, among other relevant information, records the amount of the transaction, the parties involved in the transaction, and the time of the transaction.

The History Component (20) is essentially a follow-up tool. It records all successful and unsuccessful events in the system. Successful events could provide data to generate reports. Unsuccessful events, with the reasons (if any are cited) for the failure, could help to track and repair problems. For example, in the auction of a lead, if there is no bidder among the brokers and the reason for this was a bad credit report, then this component triggers an automated event at an appropriate time (for example, when the bad credit report is no longer valid) to explore the possibility of reselling the lead again through the Lead Auction Engine (50).

There are two databases included in FIG. 2, the Lead Database (12), and the Lead Bid Database (14). There could be additional databases for the Lead Auction Engine depending on a number of factors including security, performance, the revenue model of the business, and the volume of data. The Lead Database stores all data required by the Lead Auction Engine including credit reports for hot leads. However, for security, better protection of the revenue model of the business, and performance, a separate Lead Bid Database stores data relating to the auction process itself. This database gathers its data from both the Lead Database and the Lead Auctioning Component (30). Because the two databases belong to separate processes (the creation of hot leads and the auctioning of hot leads), if the Lead Database is compromised or a table corrupted an auction could continue to function. On the other hand, if the Lead Bid Database were down, the Lead Database would still be available for borrowers to register in the system as hot leads. Additionally, this modular architecture provides extra security to the system since the Lead Bid Database is read-only for the brokers and the Lead Database is both read-write for the borrowers but not accessible to brokers. The separation of the hot lead creation process from the lead auctioning process, enabled by the use of separate databases, also allows for better overall system performance. In addition to improved security and performance, multiple databases provide flexible and faster backup/restore and maintenance solutions.

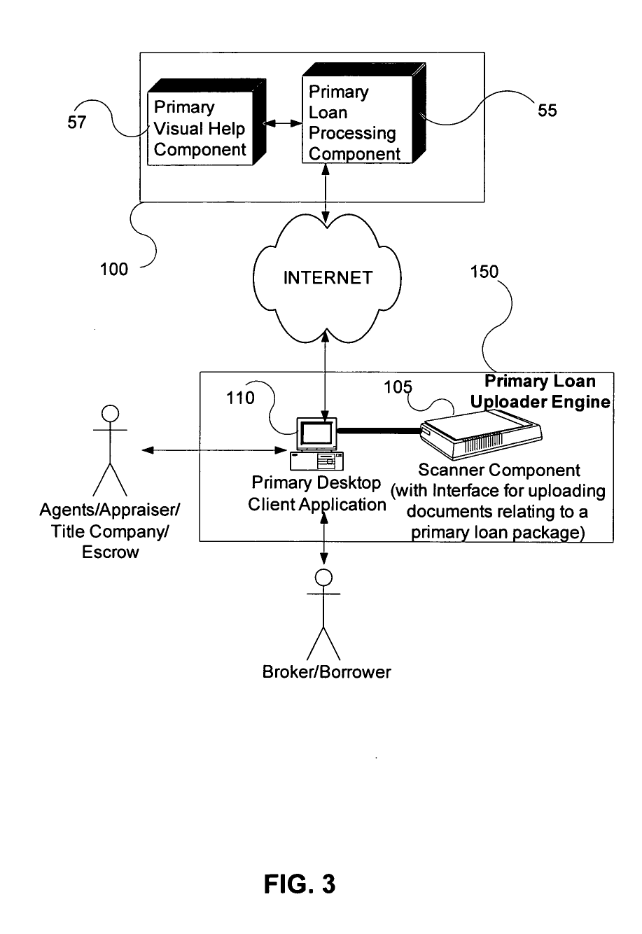

Once the lead is auctioned, the system proceeds to build a primary underwritable loan package using the lead information and other documents. The Primary Loan Uploader Engine (150) assists in putting the primary underwritable loan package together. FIG. 3 displays the components that comprise the Primary Loan Uploader Engine and components from the Primary Loan Auction Engine it communicates with in uploading primary loan package documents into the system. They are a Primary Desktop Client Application (110), a Scanner Component (105), a Primary Visual Help Component (57), and a Primary Loan Processing Component (55).

The Primary Loan Uploader Engine (150) is used by brokers and third parties belonging to the mortgage industry (contingent on having access to the Primary Loan Uploader Engine), such as Escrow, Loan Agent, Title, and Appraiser, to upload scanned images of the primary loan package documents to the system's Primary Loan Processing Component (55) over the Internet 130 (FIG. 1). A broker works with a borrower and third parties to get the documents ready to complete the underwritable primary loan package. There are several different types of documentation types including full doc, lite doc, stated, and so forth. For example, a fully underwritable full doc loan package includes the following documents: 1003 loan application, 1008 (summary of the loan application), credit report, signed original 1003 application, initial signed credit disclosures (e.g., borrower's authorization, and good faith estimate), title report, purchase agreement, appraisal report, two years of W-2 forms or 1040 form if self-employed, two most recent paycheck stubs, verification of employment (VOE), and verification of deposits (VOD). In certain embodiments, an underwritable loan package comprises at least the 1003 application and the credit report. In another embodiment, the underwritable loan package also includes the 1008 summary.

The Primary Desktop Client Application (110) provides users with an interface to the Scanner Component (105) to scan documents belonging to the loan package. As each individual document of the loan package is scanned, the Primary Desktop Client Application automatically files the scanned images along with file properties recording the type and status of the document. (For example, the status of each document could be classified as “complete,” “in process,” or “pending.”) Many documents could be uploaded directly from the offices of Escrow, Agents, Title Company, and Appraiser using the Primary Desktop Client Application and Scanner Component. This saves significant time in putting together the primary loan package. Third parties not having access to the Primary Desktop Client Application and Scanner Component receive faxed requests for documents belonging to the primary loan package from a broker via the system's Fax Server Component 35 (FIG. 2). The broker uploads the documents into the system upon receiving them from third parties. It is to be understood that a combination of systems could be utilized to input information. For example, subject to the acceptance of digital signatures, the entire underwritable loan package could be input electronically, or the loan documents could be input by a combination of methods, for example, electronically by email or any other means other than scanning paper documents.

The Primary Loan Processing Component (55) accepts the uploaded images and arrange them in an order specified by the broker. This component also mirrors the state of the loan package as maintained by the Primary Loan Uploader Engine. This allows a broker to view the uploaded underwritable loan package using a web browser. The Primary Loan Processing Component obtains a borrower's wish list from the Lead Auction Engine 50 (FIGS. 1 and 2) and provides the broker an opportunity to review and update the wish list as required. The Primary Visual Help Component (57) assists the broker in validating a borrower's wish list and gathers real-time data from third parties (that may or may not include data from mortgage bankers) to provide accurate feedback to the broker about a borrower's wish list. For example, current interest rates and acceptable down payment could be ascertained to determine whether the borrower's wish list was within currently accepted ranges. In this regard, the borrower could be advised if their wish list might have a low probability of receiving bids such that modifications could be made to the wish list to more acceptable ranges, thereby reducing the probability that the loan does not receive any bids in the auction. Note that finalizing the wish list may or may not require cooperation between the borrower and broker. Once the primary underwritable loan package and wish list are both ready, this component updates the status of the primary underwritable loan package as complete.

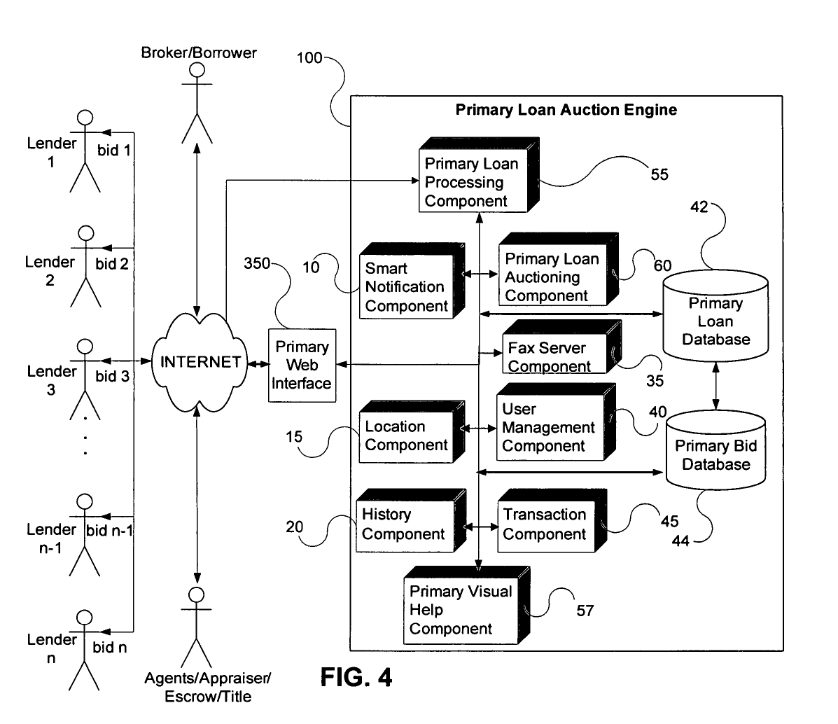

Once the primary underwritable loan package is ready, the broker and borrower are able to sign-off on the auction of the loan. The Primary Loan Auction Engine (100) implements the auction. FIG. 4 displays the components comprising the Primary Loan Auction Engine. These components are the Primary Loan Processing Component (55), the Smart Notification Component (10), the Location Component (15), the History Component (20), a Primary Loan Auction Component (60), the Fax Server Component (35), the User Management Component (40), a Primary Loan Database (42), a Primary Bid Database (44), Primary Visual Help Component (57), and the Transaction Component (45). Note that components 60, 42, and 44 are new components; the other components have are already been described in the context of the Lead Auction Engine and the primary loan uploading process (see the text accompanying FIGS. 2 and 3). These previously mentioned components perform virtually identical functions in the present context.

When a borrower and broker sign-off on a primary underwritable loan package, the Primary Loan Processing Component (55) provides the data for the entire loan package to the Primary Loan Auctioning Component (60). As with a lead auction, the Smart Notification Component (10) is configured to notify mortgage bankers about important system events, such as the start of an auction of a new primary loan package and the outcome of an auction. The Location Component (15) filters data based on geographic locations. The Fax Server Component (35) is used here to notify mortgage bankers of the primary loan auction via fax. The User Management Component (40) provides controlled system access to mortgage bankers registered with the system.

Once a mortgage banker purchases a primary underwritable loan package, the Transaction Component (45) records the transaction. In the event a primary loan package is not sold in an auction, the History Component (20) which records all major events in the system stores information relevant to following-up on the primary loan. The primary loans that are not successfully auctioned off by the broker can be re-listed by the broker by modifying the wish list and starting the auction again.

The Primary Loan Auctioning Component (60) implements the process of auctioning primary loans. Additionally, it takes into account the standard types of information used in the mortgage industry to evaluate the risk attached to the financing of loans to facilitate viewing, searching, and analysis of primary loan packages by a mortgage banker. Such information includes the loan to value (“LTV”), the credit score, the loan amount, the loan term/program (3/27, 2/28, 5/1ARM etc.), the loan purpose (purchase or refinance), the property type (single family residence (SFR), condo, attached, detached, the number of units etc), the county/city location, the documentation type (full doc, lite doc, stated, no doc, no ratio, etc.), “appraised for,” employment seasoning, rental seasoning, and loan seasoning (wherein ‘seasoning’ refers to restrictions on time periods to perform a desired action, such as, refinancing a loan). The Primary Loan Auctioning Component only displays a snapshot of the loan package, hiding certain personal information for privacy and other business and legal issues. If, given this snapshot information about the loan package, the mortgage banker selects the loan then another level of detailed information about the loan package would be displayed Again hiding the borrower's personal information. This detailed information provides mortgage bankers with sufficient information to decide whether they want to bid or not. Upon studying this information in detail, a mortgage banker feeling confident about the loan package could proceed to the actual bidding level. Before bidding, a mortgage banker must accept the system's online legal and confidentiality agreement. At the bidding level, the complete loan package (a mirror image copy of the actual loan package residing with the broker), including the borrower's personal information, is exposed to a mortgage banker. In the bidding level, a mortgage banker, having seen the complete loan package with personal information, will not have the option to withdraw. A mortgage banker must either bid on the loan package or provide PTD (Prior to Docs) or PTF (Prior to Funding) conditions or both, in which case the bid is considered inactive, as explained below.

The primary loan auction process, as implemented by the Primary Loan Auctioning Component (60), is outlined below. The auction of a loan involves a much more complex process than a conventional auction. While dollar amounts are used to bid in conventional auctions, the system uses the wish list of a borrower/broker for managing bids. The auction starts and ends at a specified time, giving a fixed window of time to the mortgage bankers to participate in the auction. When the auction closes, the highest bidder automatically wins without human intervention.

A mortgage banker bid is valid if the mortgage banker agreed to satisfy items from a borrower's wish list. Note that, depending on business requirements, it is decided whether a mortgage banker has to satisfy at least one item (or some other minimum number of items from the wish list) or the entire borrower/broker wish list in order to qualify its bid. The first mortgage banker bid is accepted if the mortgage banker agrees to satisfy the required number of items from a wish list. A subsequent mortgage banker bid is accepted only if it outbids its predecessor. Note that, again depending on business requirements, it must be decided whether a subsequent bid is valid only when outbidding at least one item from a wish list while matching the remaining items, outbidding a minimum number of items from the wish list (matching the remaining items), or outbidding the entire list of items belonging to a broker's/borrower's wish list. Decisions as to the criteria for valid bids involve compromises between protecting a borrower's/broker's interest and attracting mortgage banker interest and bids. For example, requiring a mortgage banker to satisfy all wish list items might completely protect the borrower's/broker's interest. (A portion of a broker's profit is determined by the rebate that the mortgage banker provides to the broker. The broker can add the rebate value as one item in the wish list to ensure its own profit from the transaction.) However, this might be too unattractive for the mortgage banker to participate in the auction.

Often mortgage bankers are only willing to fund a loan subject to some conditions being met by a borrower/broker; the mortgage banker will agree to fund the loan only after the broker/borrower agrees to meet the mortgage banker's extra conditions. In order to accommodate this scenario, the Primary Loan Auctioning Component would allow mortgage banker bids with conditions. However, such bids are not be treated as regular valid bids (called “active” bids) but as “inactive” bids. Inactive bids do not participate in the auction; they could not win. An inactive bid becomes an active bid only if a broker/borrower meets the conditions set forth by mortgage banker. Based on the attractiveness of an inactive bid, a broker/borrower decides whether it was worth the time and resources to meet the conditions attached to the inactive bid. Once those conditions are met, an inactive bid becomes active and takes its place among the list of active bids, ranked according to the auction rules as discussed above. The winning mortgage banker from an auction is required to accept the primary loan package and proceed for funding. The broker mails the complete loan package to the winning mortgage banker together with an electronic submission. However, in the future, subject to the acceptance of digital signatures in the mortgage industry, the entire loan package could be submitted and funded electronically. The Primary Loan Auctioning Component may also offer an optional “buy it now” loan package in some situations, for example, if the loan package is expected to be extremely attractive to the mortgage bankers. If there is no active bidder when an auction closes, the broker is provided multiple opportunities to resubmit to auction the primary loan package with modified wish list items.

To illustrate the auction of a loan, an example is presented below (see Table 1: Loan Auction Method 1). The first Column lists six wish list items: “Rate” (the actual Annual Percentage Interest Rate that is charged to a borrower's principal balance), “Prepayment Penalty” (a charge for early termination or payoff of a loan), “Closing Cost” (the cost associated with financing or refinancing a property, such as Title insurance, Escrow fees, and messenger fees, that are one time only and are negotiable in amount), “Loan Program” (period in which the borrower must payoff a loan or refinance it), “Loan Term” (the calculation of the principal and interest over the life of a loan), and “Broker Rebate” (a comnuission paid to a broker from the excess profit available to the mortgage banker). The last row provides the “Guidelines”, rules that determine what the next valid bidding minimum value is on that item. The “Initial Value” Column gives the starting value for each wish list item chosen by a broker/borrower. The “Conditions” row indicates if the mortgage banker provided a bid with conditions on the primary loan package. The “Action” row indicates whether the Primary Loan Auctioning Component accepted or rejected the mortgage banker's bid. The “Status” row indicates whether the bid is active or inactive. The four columns with bid numbers (“Bid #”) contain the bid values from bidding mortgage bankers as they occur in real time. In this example, bid number 1 (“Bid #1”), which meets all “Initial Value” criteria, is the earliest bid, has no conditions attached, and is accepted by the Primary Loan Auctioning Component as an active bid. As described above, outbidding an earlier bid can be accomplished in various ways. Here, for illustration purpose, it is assumed that a subsequent bid from a mortgage banker would be valid if it improves on at least one wish list item. The Primary Loan Auctioning Component rejects bid number 2 as it fails to beat any single wish list item. However, bid number 3 is accepted: it is an active bid and it beats bid number 1 in the “Rate” wish list item. Bid number 4 beats bid number 1 in the “Rate” wish list criterion but, as the mortgage banker requires the broker/borrower to meet a condition of providing “12 months bank statements”, the bid is only accepted by the Primary Loan Auctioning Component as an inactive bid. At the end of the auction, in this example, bid number 3 is the highest bid and wins the auction. Had the conditions of bidder number 4 been met before the auction time expired, bidder number 4 would have been the winner. Note that this method allows the mortgage banker more flexibility and freedom with wish list items since only one item needs to be improved upon to beat the previous bid (with the exception of the first bid).

TABLE 1
Loan Auction Method 1

| | Initial | | | | | |
|---|---|---|---|---|---|---|
| Wish List | Value | Bid #1 | Bid #2 | Bid #3 | Bid #4 | Guidelines |
| Rate (%) | 4.250 | 4.250 | 4.250 | 4.125 | 3.875 | Decrements of |
| | | | | | | 0.125% |
| Prepayment | 36 | 36 | 36 | 36 | 36 | Decrements of |
| Penalty | | | | | | 3 months |
| (months) | | | | | | |
| Closing | 1.000 | 1.000 | 1.000 | 1.000 | 1.000 | Decrements of |
| Cost (%) | | | | | | 0.125% |
| Loan | 60 | 60 | 60 | 60 | 60 | Increments of 1 |
| Program | | | | | | month |
| (months) | | | | | | |
| Loan Term | 360 | 360 | 360 | 360 | 360 | Increments of 12 |
| (months) | | | | | | months |
| Broker | 0.500 | 0.500 | 0.500 | 0.500 | 0.500 | Increments of |
| Rebate (%) | | | | | | 0.0625% |
| Conditions | | NO | NO | NO | YES, | |
| | | | | | 12MONTHS | |
| | | | | | BANK | |
| | | | | | STATEMENT | |
| Action | | ACCPTD | REJCTD | ACCPTD | ACCPTD | |
| Status | | ACTIVE | | ACTIVE | INACTIVE | |

To illustrate how the auction process might be varied, another example is presented (see Table 2: Loan Auction Method 2). This method requires that the Primary Loan Auctioning Component accept bids successive to the first valid bid only when all the wish list items improve upon the current bid values. Bid number 2 is rejected as it fails to outbid the “Broker Rebate” value. Bid number 3 beats all the wish list items with respect to bidder 1 and is accepted as an active bid by the system. Bid number 4, though it beats every wish list item with respect to bid number 3, is only accepted as an inactive bid because of the attached “12 months bank statements” condition. Here it is assumed that the broker meets the condition before the auction expires and hence bidder number 4 is the eventual winner of the auction. Note that this method minimizes the freedom and flexibility of the mortgage banker with respect to the wish list items.

TABLE 2
Loan Auction Method 2

| A. Wish | Initial | | | | | |
|---|---|---|---|---|---|---|
| List | Value | Bid #1 | Bid #2 | Bid #3 | Bid #4 | Guidelines |
| Rate (%) | 4.250 | 4.250 | 3.875 | 3.750 | 3.625 | Decrements of |
| | | | | | | 0.125% |
| Prepayment | 36 | 36 | 33 | 30 | 27 | Decrements of |
| Penalty | | | | | | 3 months |
| (months) | | | | | | |
| Closing Cost | 1.000 | 1.000 | 0.875 | 0.750 | 0.625 | Decrements of |
| (%) | | | | | | 0.125% |
| Loan Program | 60 | 60 | 61 | 62 | 63 | Increments of 1 |
| (months) | | | | | | month |
| Loan Term | 360 | 360 | 372 | 384 | 396 | Increments of 12 |
| (months) | | | | | | months |
| Broker Rebate | 0.500 | 0.500 | 0.500 | 0.563 | 0.625 | Increments of |
| (%) | | | | | | 0.0625% |
| Conditions | | NO | NO | NO | YES, | |
| | | | | | 12MONTHS | |
| | | | | | BANK | |
| | | | | | STATEMENT | |
| Action | | ACCPTD | REJCTED | ACCPTD | ACCPTD | |
| Status | | ACTIVE | | ACTIVE | INACTIVE | |

The third method presented here illustrates a compromise between method 1 and method 2 to balance the freedom and flexibility of a mortgage banker's options in satisfying wish list items against the interests of a broker/borrower in having wish list items optimized (see Table 3: Loan Auction Method 3). This method requires that some minimum number of wish list items (in this case two items: “Rate” and “Prepayment Penalty”) from the current bid must be improved upon for a subsequent bid to be accepted as a valid bid (with the exception of the first bid which must match or improve upon the initial values). After bid number 1, which matches the initial values and is accepted, the Primary Loan Auctioning Component rejects the second bid. This is because even though it provides better values on wish list items that are not mandatory (“Closing Cost”, “Loan Program”, “Loan Term”, and “Broker Rebate”), it fails to beat the mandatory wish list item of “Prepayment Penalty”. Bid number 3 is accepted as it provides better values on the mandatory wish list items. Note that it also provided a better value (0.750) for the non-mandatory wish list item of “Closing Cost”. This is allowed but it is not a required condition for accepting the bid. However, the next bidder then has to provide at least 0.750 on “Closing Cost”. Bid number 4 is accepted as it beats the current mandatory wish list items but, because of an attached “12 months bank statements” condition, it is accepted as an inactive bid. It is assumed that the broker/borrower meets this condition of bidder number 4 before the auction expires and is the eventual winner of the auction. Method 3 provides a balance between method 1 and method 2. At the end of the auction, assuming that there is at least one active bid, it is guaranteed that the initial values of the mandatory items in the wish list will at least be matched and possibly bettered while the non-mandatory items need never be improved upon. This method therefore tends to result in better values for mandatory wish list items. While it may be left to the broker/borrower to decide which items to make mandatory, it is also possible that the system may not provide the choice in order to avoid situations where the mandatory items leave little room for bidding beyond the first bid. For example, having both the broker rebate and the rate as mandatory items restricts a mortgage banker's ability to make multiple bids because the broker rebate and the rate are essentially the same to a mortgage banker. A variation on method 3 is to make the broker rebate a mandatory item for even-numbered active bids. This increases the possibility of providing the broker with a better rebate value and the borrower a better rate without discouraging bidding from mortgage bankers.

Thus, several variations to the auction process are possible to meet business requirements. The auction may also allow proxy bidding as explained earlier. It should be noted that the auction processes of the Primary Loan Auctioning Component are not limited to the implementation of the different methods presented here which are for illustration purpose only. The component is capable of other embodiments and of being practiced and carried out in various ways to suit business requirements.

TABLE 3
Loan Auction Method 3

| | Initial | | | | | |
|---|---|---|---|---|---|---|
| Wish List | Value | Bid #1 | Bid #2 | Bid #3 | Bid #4 | Guidelines |
| Rate (%) | 4.250 | 4.250 | 3.875 | 3.750 | 3.625 | Decrements of |
| | | | | | | 0.125% |
| Prepayment | 36 | 36 | 36 | 30 | 27 | Decrements of |
| Penalty | | | | | | 3 months |
| (months) | | | | | | |
| Closing | 1.000 | 1.000 | 0.875 | 0.750 | 0.625 | Decrements of |
| Cost (%) | | | | | | 0.125% |
| Loan | 60 | 60 | 61 | 60 | 63 | Increments of 1 |
| Program | | | | | | month |
| (months) | | | | | | |
| Loan Term | 360 | 360 | 372 | 360 | 360 | Increments of 12 |
| (months) | | | | | | months |
| Broker | 0.500 | 0.500 | 0.563 | 0.500 | 0.500 | Increments of |
| Rebate (%) | | | | | | 0.0625% |
| Conditions | | NO | NO | NO | YES, | |
| | | | | | 12MONTHS | |
| | | | | | BANK | |
| | | | | | STATEMENT | |
| Action | | ACCPTD | REJCTD | ACCPTD | ACCPTD | |
| Status | | ACTIVE | | ACTIVE | INACTIVE | |

There are two databases included in FIG. 4, the Primary Loan Database (42) and the Primary Bid Database (44). There could be additional databases for the Primary Loan Auction Engine depending on a number of factors including security, performance, the revenue model of the business, and the volume of data. The Primary Loan Database stores all data required by the Primary Loan Auction Engine including the entire loan package and the wish list of the broker. However, for security, better protection of the revenue model of the business, and performance, a separate Primary Bid Database stores data inputted during the auction process itself. This database gathers its data from both the Primary Loan Database and the Primary Loan Auctioning Component (60). Because the two databases belong to separate processes (the creation of a primary loan package and the auctioning of a primary loan package), if the Primary Loan Database is compromised or a table corrupted, an auction could continue to function. On the other hand, if the Primary Bid Database were down the Primary Loan Database would continue to service brokers in putting together primary loan packages. Additionally, this modular architecture provides extra security to the system since the Primary Bid Database is read-only for the mortgage bankers and the Primary Loan Database is both read-write for the brokers but not accessible to mortgage bankers. The separation of the primary loan package preparation process from the primary loan auctioning process, enabled by the use of separate databases, also allows for better overall system performance. As was the case with the Lead Auction Engine, in addition to improved security and performance, multiple databases provide flexible and faster backup/restore and maintenance solutions.

Once the primary loan is auctioned, the Smart Notification Component (10) notifies mortgage bankers of the auction outcome. If the winning mortgage banker is a “Lender-Plus Member”, in addition to the option of servicing the loan as a portfolio loan, the mortgage banker has the option of selling it to investors in the secondary market. Lender-Plus Members are mortgage bankers who satisfy certain additional criteria beyond those required for standard registration with the system. These additional criteria can be of several forms; for example, a criterion can be as straightforward as requiring the periodical payment of an additional amount to maintain this status or it can be performance related, such as a condition to maintain a certain volume of transactions in the Primary Loan Auction Engine. (In the context of selling secondary loans, “mortgage banker” will be used synonymously with “Lender-Plus Member”.)

When the winning bidder in a primary loan auction is a Lender-Plus Member, if desired by the Lender-Plus Member, the primary loan package can be automatically transferred from the Primary Loan Auction Engine 100 (FIG. 1) to the Secondary Loan Auction Engine 200 (FIG. 1). The Smart Notification Component (10) notifies winning Member-Plus Lenders that they should begin processing the secondary loan package for auction. In the event a secondary loan package is not completed within a specified period, the primary loan package is withdrawn from the system and securely stored off-line (for example, on a tape drive). The History Component (20) records the event. In the interim, the Lender-Plus Member receives periodic reminders to initiate completion of a secondary loan package before the expiration of the allowed time.

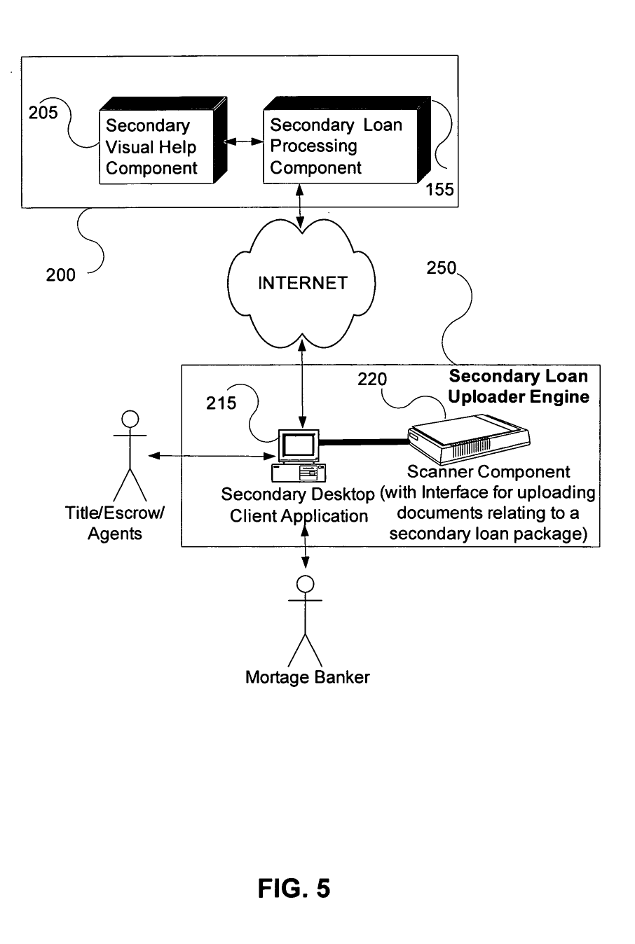

Mortgage bankers use the existing primary loan package documents and add additional documents required to complete the secondary loan package. FIG. 5 displays the components that comprise the Secondary Loan Uploader Engine (250) and components from the Secondary Loan Auction Engine it communicates with in uploading secondary loan package documents into the system. They are a Secondary Desktop Client Application (215), a Scanner Component (220), a Secondary Visual Help Component (205), and a Secondary Loan Processing Component (155).

The Secondary Loan Uploader Engine (250) plays a virtually identical role in the context of the auction of secondary loan packages as the Primary Loan Uploader Engine does for the auction of primary loan packages. The Secondary Loan Uploader Engine is used by mortgage bankers and possibly third parties belonging to the secondary market mortgage industry (contingent on having access to the Secondary Loan Uploader Engine), such as Escrow, Loan Agent, and Title 124 (FIG. 1), to upload the scanned images of the secondary loan package documents to the system's Secondary Loan Processing Component (155) over the Internet 130 (FIG. 1). A mortgage banker works with various third parties to get the documents ready to complete the secondary loan package. The Secondary Desktop Client Application (215) provides users with an interface to the Scanner Component (220) to scan documents belonging to the loan package. As each individual document of the loan package is scanned, the Secondary Desktop Client Application automatically files the scanned images along with file properties recording the type and status of the document. (For example, the status of each document could be classified as “complete,” “in process,” or “pending.”) Many documents could be uploaded directly from the offices of Escrow, Loan Agent, and Title using the Secondary Desktop Client Application and Scanner Component. This saves significant time in putting together a secondary loan package. Third parties not having the Secondary Desktop Client Application and Scanner Component receive faxed requests for documents belonging to the secondary loan package from a mortgage banker via the system's Fax Server Component 35 (FIG. 4). The mortgage banker uploads the documents into the system upon receiving them from third parties.

The Secondary Loan Processing Component (155) plays an analogous role in completing a secondary loan package to that of the Primary Loan Processing Component 55 (FIG. 4) in completing a primary loan package. The Secondary Loan Processing Component accepts the uploaded images and arrange them in an order specified by the mortgage banker. The Secondary Loan Processing Component also mirrors the state of the secondary loan package as maintained by the Secondary Loan Uploader Engine (250). This allows a mortgage banker to view the uploaded loan package using a web browser. The Secondary Visual Help Component (205) assists a mortgage banker in creating a wish list by gathering real-time data from third parties (that may or may not include data from investors). Contrary to the primary loan auction, where mortgage bankers bid on various wish list items, the secondary loan auction wish list consists of a single item, the mortgage banker rebate value. Once the secondary loan package and wish list are both ready, the Secondary Loan Processing Component updates the status of the secondary loan package as complete.

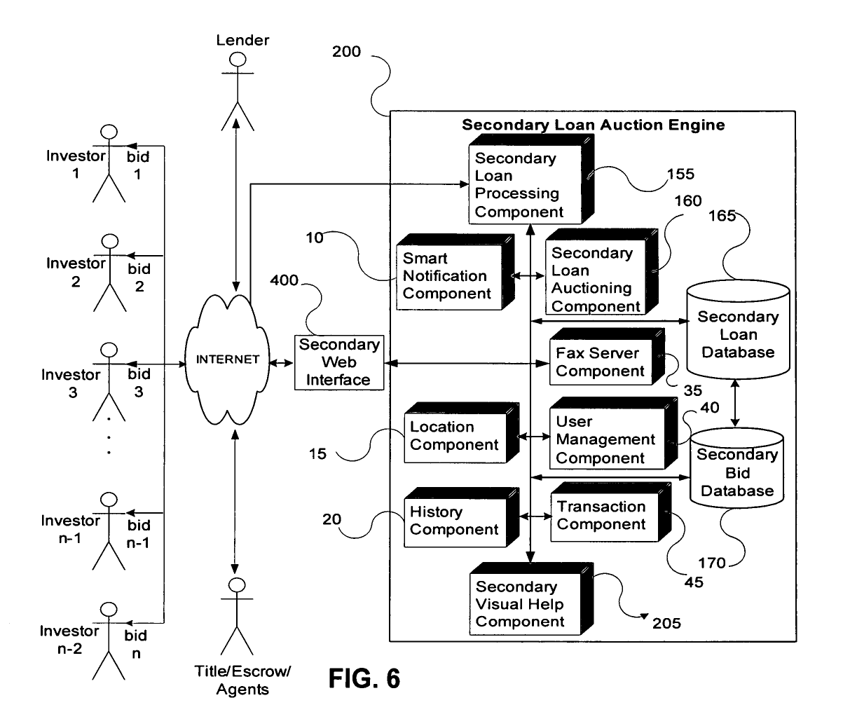

Once the secondary loan package is ready, a mortgage banker is able to sign-off on the auction of the loan. The Secondary Loan Auction Engine (200) will implement the auction. FIG. 6 displays the components comprising the Secondary Loan Auction Engine. These components are the Secondary Loan Processing Component (155), the Smart Notification Component (10), the Location Component (15), the History Component (20), a Secondary Loan Auctioning Component (160), the Fax Server Component (35), the User Management Component (40), a Secondary Loan Database (165), a Secondary Bid Database (170), the Secondary Visual Help Component (205), and the Transaction Component (45). Note that components 160, 165, and 170 are new components; the other components have are already been described in the context of both the Lead and Primary Auction Engines (50 and 100) and both the primary and secondary loan uploading process (see the text accompanying FIGS. 2, 3 and 5). These previously mentioned components again perform virtually identical functions in the present context.

When a mortgage banker signs-off on a secondary loan package, the Secondary Loan Processing Component (155) performs a required check for consistency with the data already processed by the Lead and the Primary Loan Auction Engines before sending the entire secondary loan package to the Secondary Loan Auctioning Component (160). As with a lead and a primary loan auction, the Smart Notification Component (10) is configured to notify all registered investors about important system events, such as the start of an auction of a new secondary loan package and the outcome of an auction. The Location Component (15) filters data based on geographic locations. The Fax Server Component (35) would be used here to notify investors of the secondary loan auction via fax. The User Management Component (40) provides controlled system access to investors registered with the system. Once an investor purchases a secondary loan package, the Transaction Component (45) records the transaction. In the event a secondary loan package is not sold in an auction, the History Component (20), which records all major events in the system, stores information relevant to following-up on the secondary loan.

The Secondary Loan Auctioning Component (160) implements the process of auctioning secondary loan packages. Additionally, it takes into account the standard types of information used in the mortgage industry to evaluate the risk attached to the financing of loans to facilitate viewing, searching, and analysis of secondary loan packages by an investor. Such information includes the LTV, the credit score, the loan amount, the loan term/program (3/27, 2/28, 5/1 ARM etc.), the loan purpose (purchase or refinance), the property type (SFR, condo, attached, detached, the number of units, etc), the county/city location, the documentation type (full doc, lite doc, stated, no doc, no ratio, etc.), “appraised for,” employment seasoning, rental seasoning, and loan seasoning. The Secondary Loan Auctioning Component only displays a snapshot of the loan package, hiding certain personal information for privacy and other business and legal issues. If, given this snapshot information about the loan package, the investor selects the loan, then another level of detailed information about the loan package is displayed. However, at this level the borrower's personal information remains hidden. This detailed information provides investors with sufficient information to decide whether they want to bid or not. Upon studying this information in detail, an investor feeling confident about the loan package could proceed to the actual bidding level. Before bidding, an investor must accept the system's online legal and confidentiality agreement. At the bidding level the complete loan package (a mirror image copy of the actual loan package residing with the mortgage banker), including the borrower's personal information, is exposed to an investor. In the bidding level an investor, having seen the complete loan package with personal information, will not have the option to withdraw. An investor must either bid on the loan package or provide Prior to Docs/Prior to Funding conditions.

It should also be noted that investors often buy loans in pools. In that case, the multiple loans are bundled together and summary information would be displayed to the investor for bidding. However, an investor has the ability to examine individual loan packages in the same manner as described above.

A secondary loan auction proceeds similar to a primary loan auction except, as mentioned, the wish list in this case consists of a single, mandatory item, the rebate value. The bid amount from an investor is based on the rebate provided to mortgage bankers. The auction starts with a minimum rebate value set by a mortgage banker. For a first bid to be valid, it has to match this minimum rebate value. A succeeding bid is registered only if the investor bids a higher rebate value than the current bid value.

As was the case with the primary loan market, in some situations investors are willing to purchase a loan only with some extra conditions attached. They will purchase the secondary loan only after the mortgage banker agrees to meet these additional conditions. For example, one condition might be the provision of additional documents toward the secondary loan package. In order to accommodate this scenario, the Secondary Loan Auctioning Component (160) also allows bids with conditions. However, as with the auction of primary loan packages, they are not registered as regular bids but displayed as inactive bids. Again, inactive bids do not participate in the auction and become active only if the mortgage banker meets the conditions set forth by an investor. Based on the attractiveness of an inactive bid, a mortgage banker decides whether it was worth the time and resources to meet the conditions attached to the inactive bid. If those conditions are met, an inactive bid becomes active and take its place among the list of active bids, ranked according to the auction rules as discussed above.

The winning investor from an auction is required to accept the secondary loan package and proceed for funding. The mortgage banker mails the complete secondary loan package to the winning investor together with an electronic submission. However, in the future, subject to the acceptance of digital signatures in the mortgage industry, the entire secondary loan package could be submitted and funded electronically.

The Secondary Loan Auctioning Component may also offer an optional “buy it now” loan package in some situations, for example, if the loan package is expected to be extremely attractive to investors. As with the auction of a primary loan package, a secondary loan package could be resubmitted by the mortgage banker with a modified wish list item if it is not bid on in the previous auction. Also as with the primary loan auction, the secondary loan auction may also allow proxy bidding.

The modular database architecture of the Lead and Primary Loan Auction Engines is repeated with the Secondary Loan Auction Engine. There are two databases included in FIG. 6, the Secondary Loan Database (165) and the Secondary Bid Database (170). There could be additional databases for the Secondary Loan Auction Engine depending on a number of factors including security, performance, the revenue model of the business, and the volume of data. The Secondary Loan Database stores all data required by the Secondary Loan Auction Engine, including the entire secondary loan package and the wish list item (the rebate value) of the mortgage banker. However, for security, better protection of the revenue model of the business, and performance, a separate Secondary Bid Database stores data inputted during the auction process itself. This database would gather its data from both the Secondary Loan Database and the Secondary Loan Auctioning Component (160). Because the two databases belong to separate processes (the creation of a secondary loan package and the auctioning of a secondary loan package), if the Secondary Loan Database is compromised or a table corrupted an auction could continue to function. On the other hand, if the Secondary Bid Database were down, the Secondary Loan Database continues to provide service to mortgage bankers in putting together secondary loan packages. Additionally, this modular architecture provides extra security to the system since the Secondary Bid Database is read-only for the investors and the Secondary Loan Database is both read-write for the mortgage bankers but not accessible to investors. The separation of the secondary loan package preparation process from the secondary loan auctioning process, enabled by the use of separate databases, also allows for better overall system performance. As was the case with the Lead and Primary Auction Engines, in addition to improved security and performance, multiple databases provide flexible and faster backup/restore and maintenance solutions.

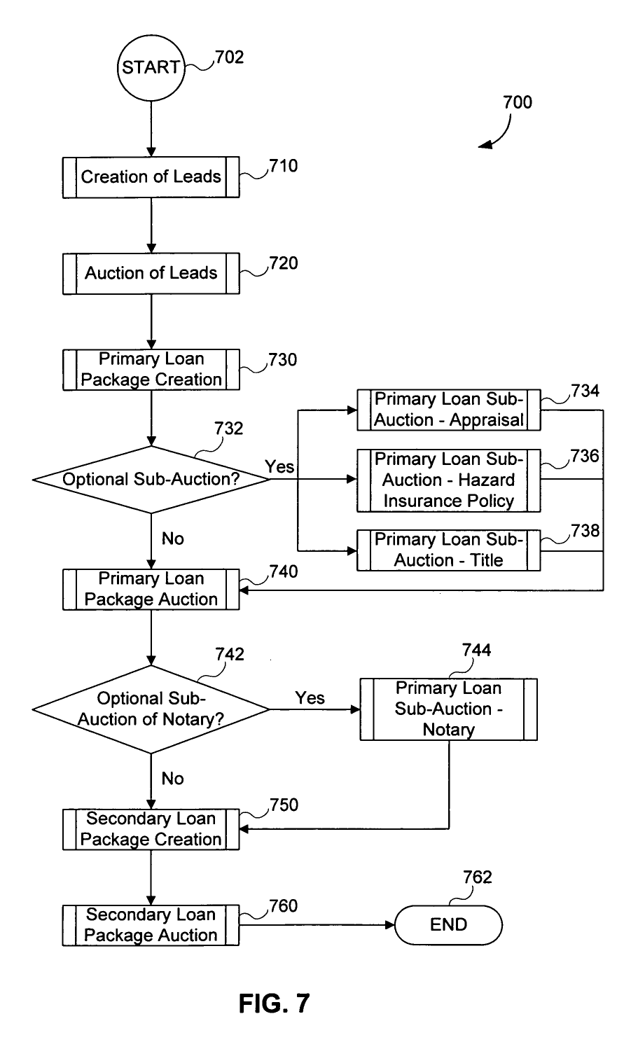

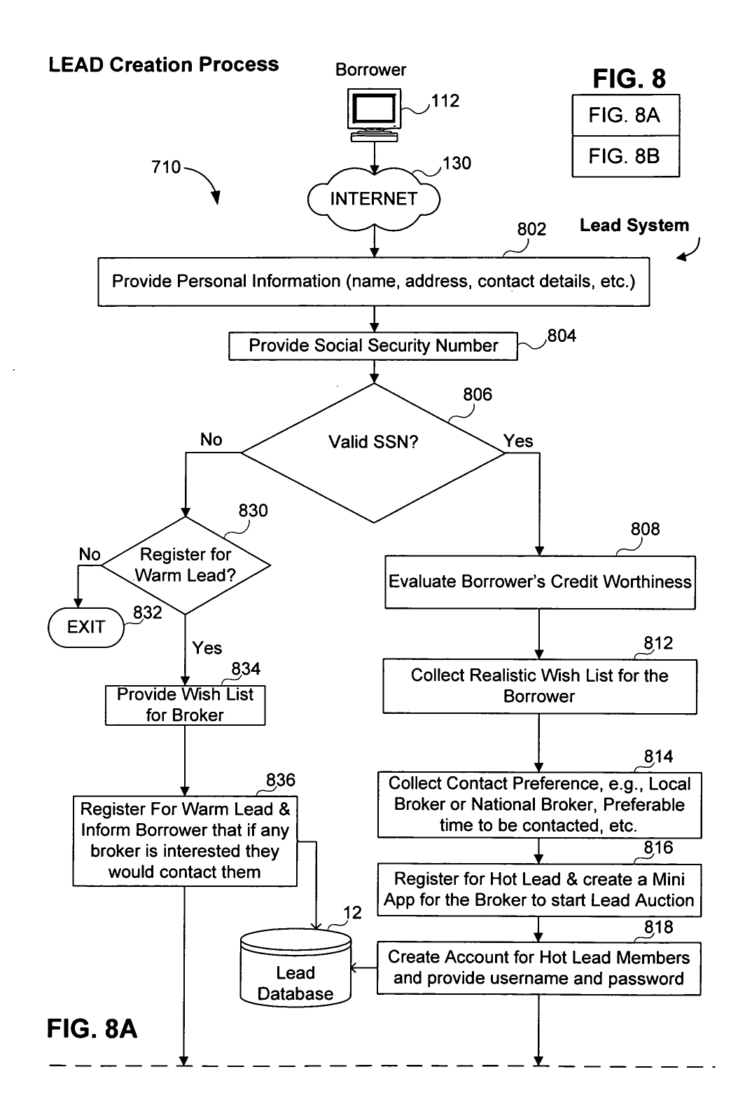

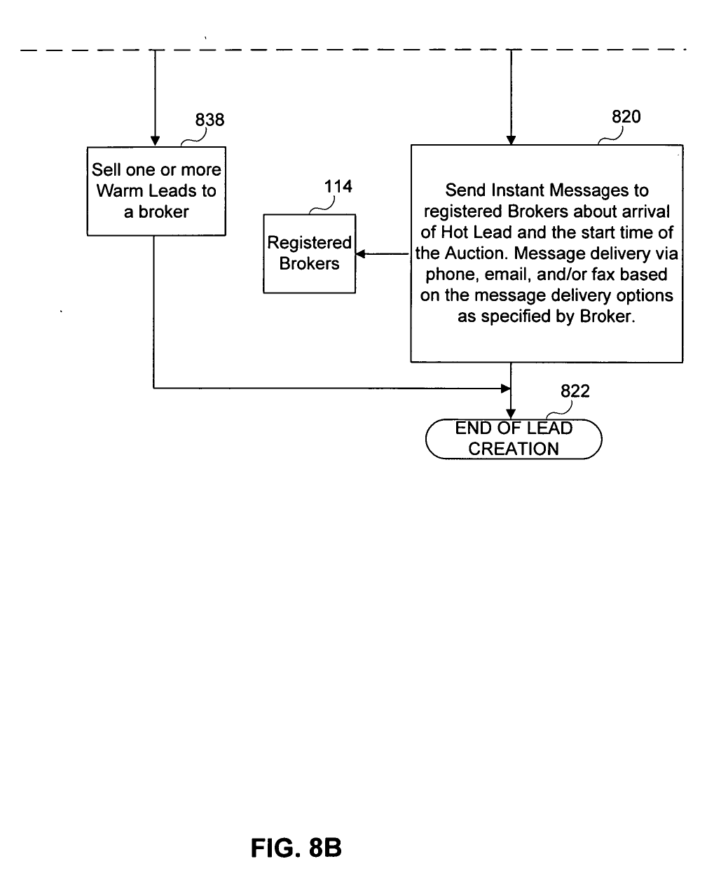

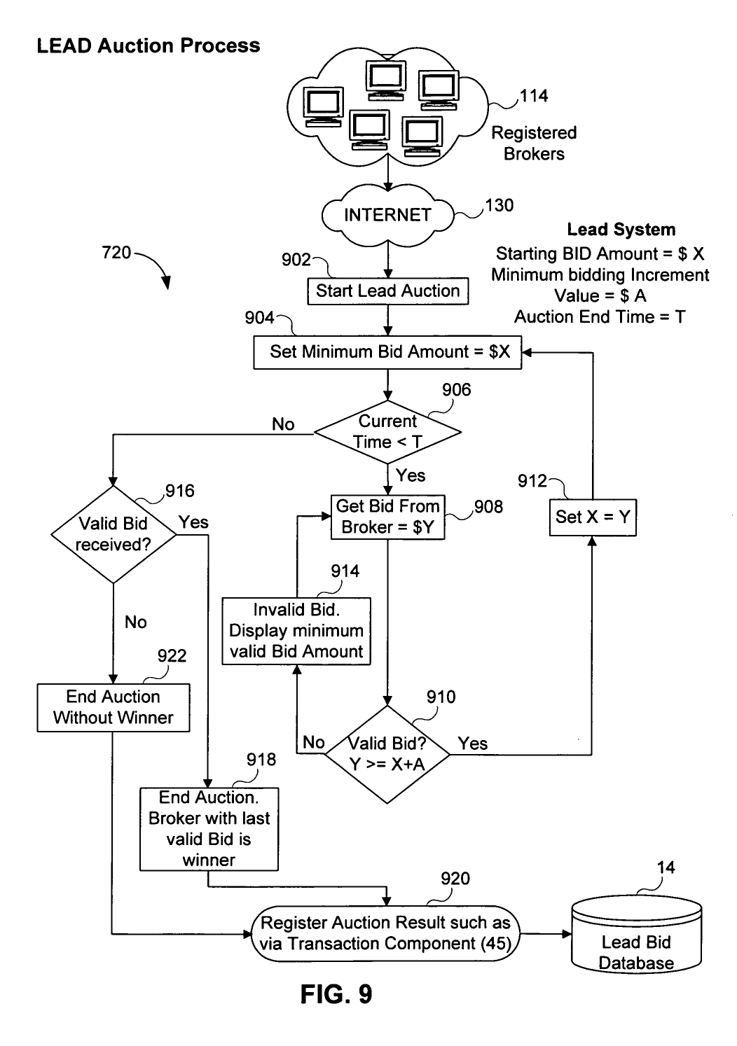

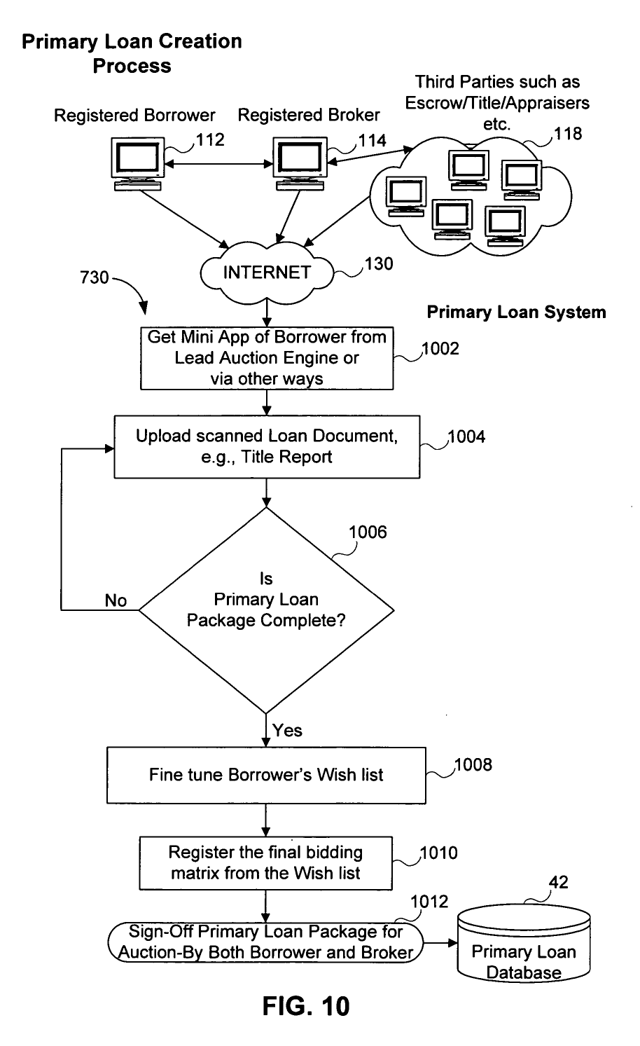

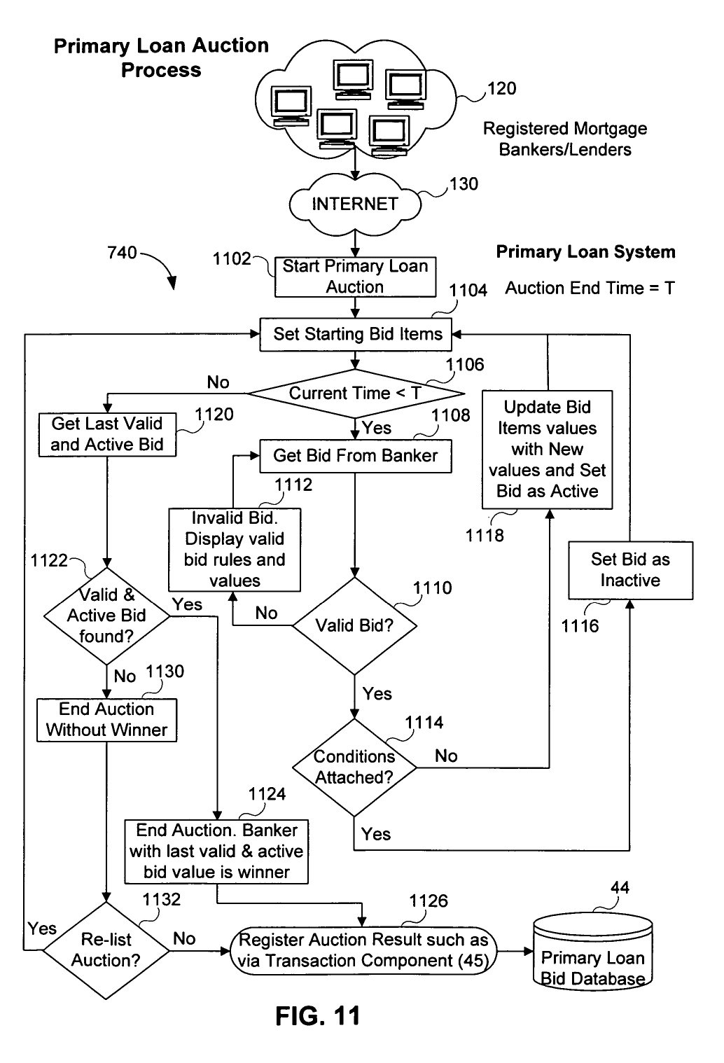

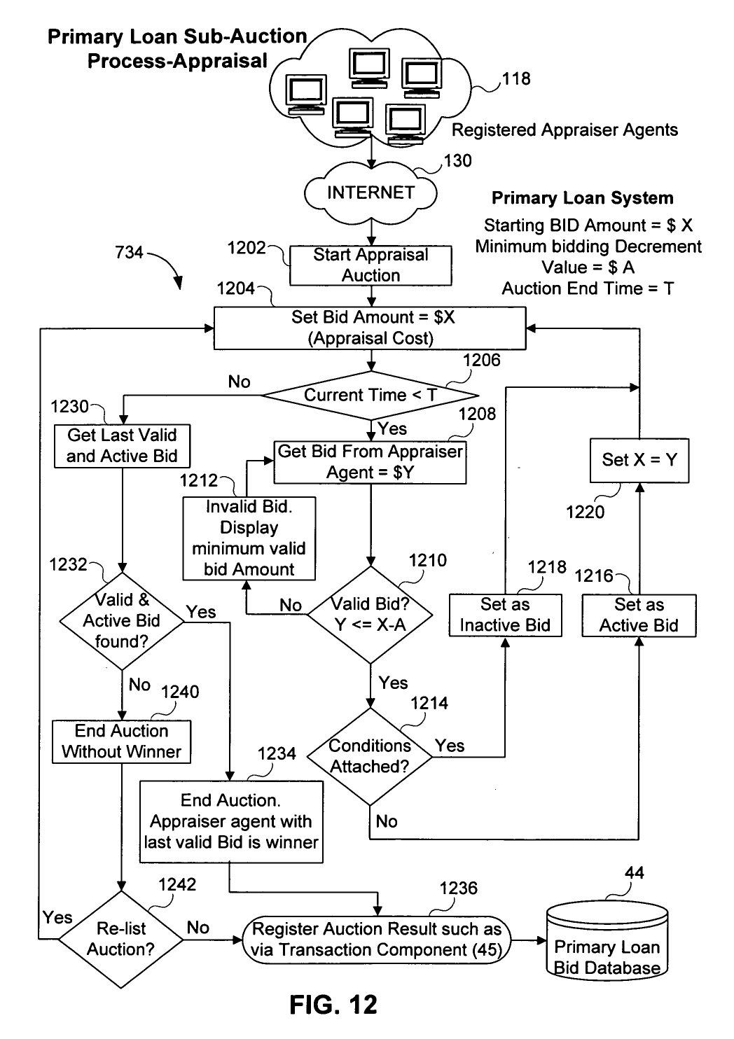

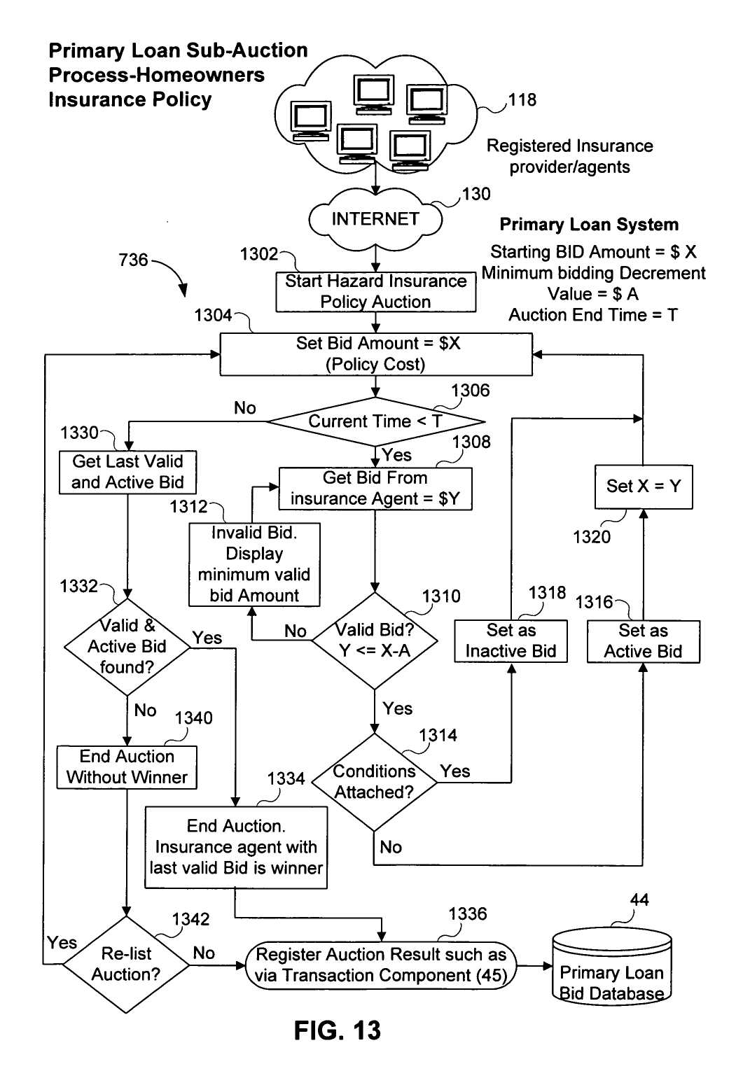

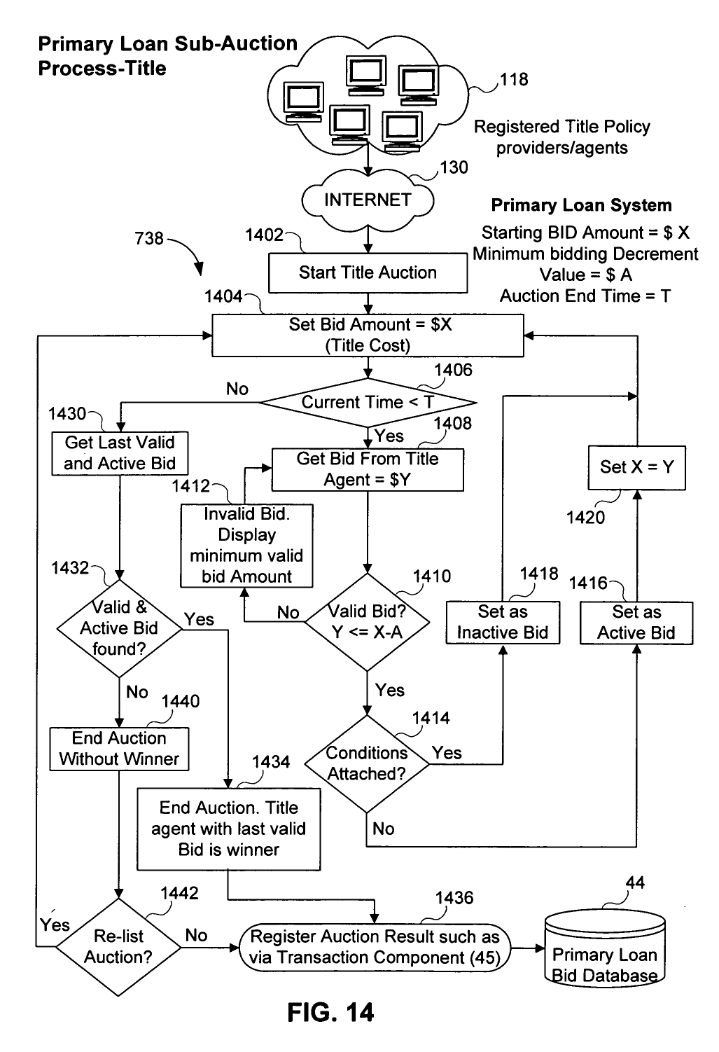

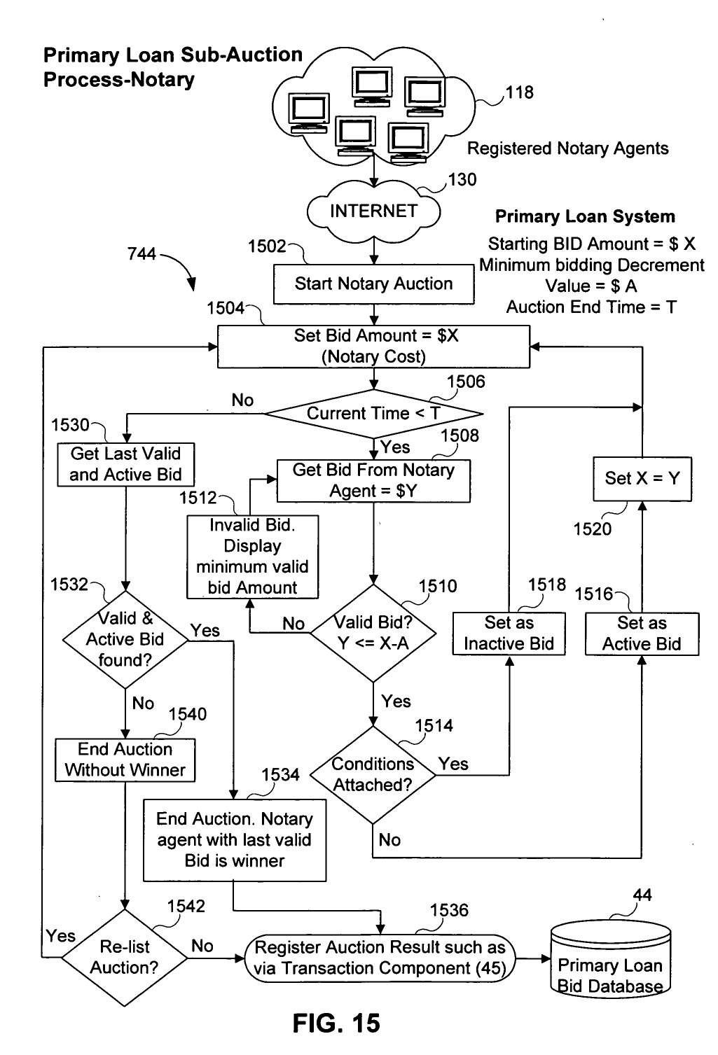

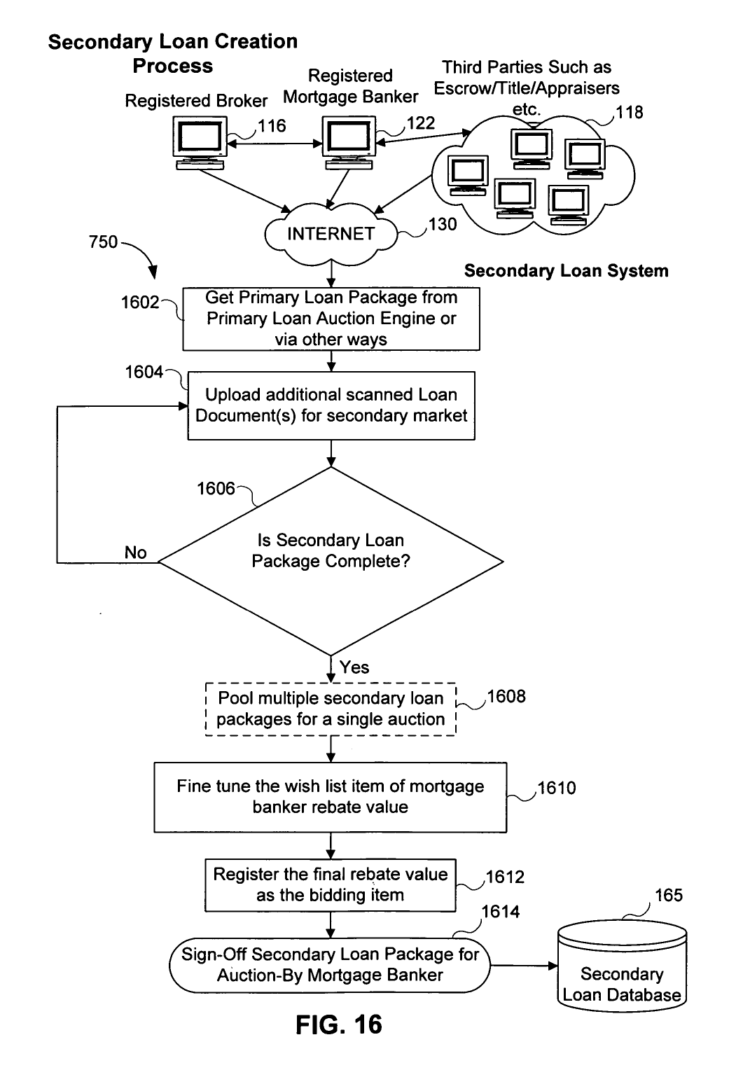

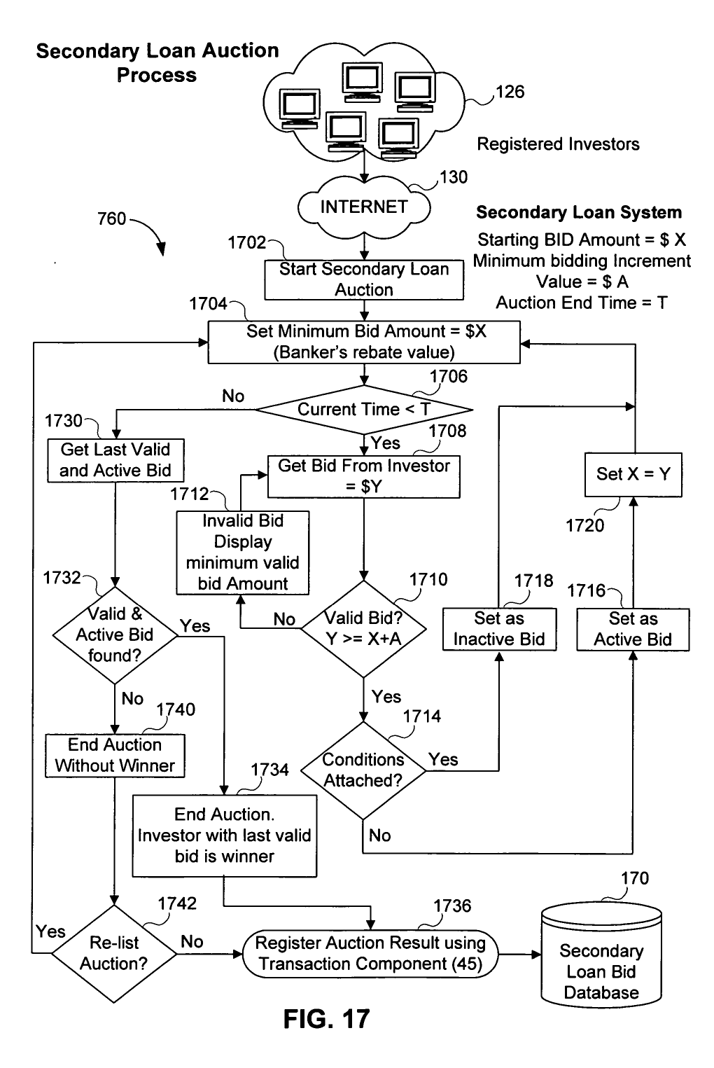

Referring to FIG. 7, a flow chart of the top level processes operating on the system shown in FIG. 1, will now be described. The system shown in FIG. 1 comprises a lead system, a primary loan system and a secondary loan system. Beginning at a start state 702, the top level process 700 proceeds to a lead creation process 710, which will be further described in conjunction with FIG. 8 below. Process 700 then advances to a lead auction process 720, which will be further described in conjunction with FIG. 9 below. Process 700 then continues to a primary loan creation process 730, as will be described in conjunction with FIG. 10 below. Process 700 then continues at a decision state 732 to determine if optional sub-auctions for one or more third party service providers should be performed. If so, process 700 advances to one of three possible sub-auctions: a primary loan sub-auction process for appraisal 734, as will be described in conjunction with FIG. 12; a primary loan sub-auction process for a homeowners insurance policy 736, as will be described in conjunction with FIG. 13; or a primary loan sub-auction process for title 738, as will be described in conjunction with FIG. 14. If, however, no optional sub-auction is to be performed, as determined at decision state 732, or at the completion of the sub-auctions 734, 736 and 738, as necessary, process 700 continues to a primary loan package auction process 740, as will be described in conjunction with FIG. 11. Process 700 then proceeds to a decision state 742 to determine if there should be an optional sub-auction of a notary. If so, process 700 proceeds to primary loan sub-auction process for notary 744, as will be described in conjunction with FIG. 15. If the optional sub-auction for notary is not performed, as determined at decision state 742, or at the completion of the primary loan sub-auction process 744, process 750 continues to a secondary loan package creation process 750, as will be described in conjunction with FIG. 16. At the completion of the secondary loan package creation process 750, process 700 advances to a secondary loan auction process 760, as will be described in conjunction with FIG. 17, and ends at an end state 762.

Referring now to FIGS. 8A and 8B, the lead creation process 710, previously described in conjunction with FIG. 7, will now be described. Process 710 is performed using the lead system portion of the overall system. The lead system portion is shown on the top part of FIG. 1. A borrower 112 communicates via the Internet 130 or other network with the lead system and provides various types of personal information such as name, address, contact details and so forth at a state 802. The personal information can be provided via the lead web interface 300 (FIG. 1). In one embodiment, the borrower provides a SSN at a state 804. In other embodiments, other nationally recognized personal identification numbers or other types of identifiers could be used by process 710. In the embodiment using a SSN, process 710 proceeds to a decision state 806 to determine if the SSN is a valid number. The SSN or other identifier can be validated using the credit bureau component 5 (FIG. 2). In other embodiments, whatever identifier is used for the borrower is checked to determine if the provided identifier is a valid identifier. If the determination is made at state 806 that the provided SSN or other identifier is valid, process 710 proceeds to a state 808 to evaluate the borrower's credit worthiness. The borrower's credit worthiness can be evaluated using the credit bureau component 5. In one embodiment, process 710 obtains the borrower's credit report based on the SSN or other identifier. Credit report evaluation is done at various levels based on the nature of the transaction that the borrower intends to do. For example, a borrower borrowing money for an automobile loan would be evaluated differently than a borrower borrowing money for real estate. The borrower is evaluated using his or her credit report together with the FICO score against industry standard rules pertaining to real estate. Process 710 then continues at a state 812 to collect wish list items from the borrower. Proceeding to a state 814, process 710 collects contact preferences of the borrower such as, for example, the use of a local or national broker, preferable times to be contacted and so forth. Continuing at state 816, process 710 then registers this application as a Hot Lead and creates a mini-application (borrower's information such as name, address, credit report, etc.) for the broker to start the lead auction. Moving to state 818, process 710 creates an account for this Hot Lead member and provides a user name and password to be used. This information along with the mini-application, are stored in a lead database 12 (FIG. 2). Process 710 then proceeds to a state 820 and, in one embodiment, uses the smart notification component 10 and the fax server component 35 to send instant messages to registered brokers about the arrival of a Hot Lead and the start time of the lead auction. The message delivery can be via telephone, e-mail and/or facsimile based on the message delivery options specified by the broker. The lead creation process 710 then completes at an end state 822.

Returning to decision state 806, if it is determined that the SSN or other identifier is not valid, process 710 then moves to a decision state 830. At decision state 830, process 710 determines if the application should be registered as a warm lead depending on whether or not the borrower provided a valid SSN or other valid identifier in other embodiments). If the borrower does not provide a valid SSN (or other valid identifier), the system prompts for a warm lead. If it is determined that the application should not be registered for a warm lead, process 710 exits at a exit state 832. However, if it is determined that the application should be registered for a warm lead, process 710 advances to a state 834 to provide a wish list for the broker. Continuing to a state 836, process 710 then registers the application for a warm lead and informs the borrower that if any broker is interested in his application that the broker would contact him. The application data and other associated information are stored in the lead database 12 (FIG. 2). Process 710 then proceeds to state 838 to consolidate one or more Warm Leads to be sold to a broker and ends at state 822.

Referring to FIG. 9, the lead auction process 720, previously described in conjunction with FIG. 7, will now be described. Multiple registered brokers 114 communicate via the Internet 130 or other network with the lead system portion of the overall system. Prior to the start of the lead auction process 720, a starting bid amount of X dollars, a minimum bidding increment value of A dollars and an auction end time of T are established. The process 720 begins at a state 902 to start the lead auction. Process 720 then advances to a state 904 to set the minimum bid amount equal to X dollars. Process 720 then continues at a decision state 906 to determine if the current time is less than T, the end auction time. If not, that is, the auction is still running, process 720 advances to state 908 to obtain a bid from a broker of Y dollars. Process 720 then proceeds to a decision state 910 to determine if the bid is a valid bid, that is, is the bid of Y dollars from the broker greater or equal to the minimum bid amount plus the increment value A. If so, process 720 proceeds to state 912 to set the broker's bid value of Y to be equal to a new value of X, such that, on a subsequent bid, the new minimum bidding value is the new X at state 904. Returning to decision state 910, if process 720 determines that the bid is not a valid bid, that is, the broker's bid value of Y is less than the minimum bid amount and the minimum increment of A, processing continues at a state 914. At state 914, the bid is designated to be invalid and the process displays a minimum valid amount to the broker, and continues back to state 908 to obtain a new bid from the broker.

Returning to decision state 906, if process 720 determines that the current time is greater or equal to the auction end time, processing continues at a decision state 916. At decision state 916, process 720 determines if a valid bid has been received so far in the auction. If so, process 720 proceeds to state 918 where the auction is stopped and the broker with the last valid bid is considered to be the winner. Process 720 then moves to state 920 where the auction results are registered, such as via transaction component 45 (FIG. 2), and the data is stored in the lead bid database 14. The auction process 720 then is completed. Returning to decision state 916, if process 720 determines that a valid bid was not received during the time of the auction, processing continues at a state 922 where the auction is ended without a winner. Process 720 then moves to state 920 to register the auction result of the auction ending without a winner, stores the information in the lead database 14 and completes.

Referring now to FIG. 10, the primary loan creation process 730, previously described in conjunction with FIG. 7, will now be described. A registered borrower 112, a registered broker 114 and various third party service providers such as escrow title appraisers and other agents 118 communicate via the Internet 130 or other network with the primary loan system portion of the overall system. The primary loan system portion is shown in the central portion of FIG. 1. At state 1002, process 730 obtains the mini-application of the borrower from the lead auction engine 50 (FIG. 1) or via other ways. These other ways may include receiving completed forms, on-line forms or other ways of obtaining the required information for a loan application. Proceeding to a state 1004, process 730 obtains one or more scanned loan documents such as a title report. These scanned loan documents can be obtained via the primary loan uploader engine 150 shown in FIGS. 1 and 3. Various third party providers, such as agents, appraisers, title companies, escrow people, can provide the necessary documents via a scanner or other similar device to interact with a client application 110. Process 730 then proceeds to a decision state 1006 to determine if the primary loan package is complete. In one embodiment, the process 730 uses the primary loan processing component 55 (FIG. 3) to make this determination. If it is determined that the package is not complete, process 730 returns to process 1004 to obtain further loan documents that are needed. If it is determined at decision state 1006 that the primary loan package is now complete, process 730 proceeds to state 1008 to fine tune the borrower's wish list. In one embodiment, process 730 uses the primary visual help component 57 (FIG. 3) for this fine tuning. At the completion of state 1008, process 730 advances to state 1010 to register the final bidding matrix based on the wish list. Process 730 then continues at state 1012 to have the primary loan package for the auction be signed off by both the borrower and the broker. The primary loan package data is stored in the primary loan database 42 (FIG. 4) and the process 730 then completes.

Referring now to FIG. 11, the primary loan auction process 740, previously described in conjunction with FIG. 7, will now be described. Registered mortgage bankers/lenders 120 communicate via the Internet 130 or other network with the primary loan system portion of the overall system. Prior to the beginning of the primary loan auction process 740, an auction end time of T is established. Process 740 starts the primary loan auction at a state 1102 and proceeds to state 1104 to set starting bid items, also referred to as borrowing criteria. In the first pass through the primary loan auction process, the bid items are set to their initial values of the final bidding matrix as previously determined, such as, for example, shown in the initial value column of Table 1 above. Process 740 then proceeds to a decision state 1106 to determine if the current time is less than the auction end time T. If so, process 740 advances to state 1108 to receive a bid from one of the registered bankers or lenders bidding in this auction. Continuing at a decision state 1110, process 740 determines if the bid is a valid bid. In one embodiment, an initial bid for the auction is a valid bid if it meets all the initial values in the final bidding matrix. Subsequent bids are considered valid if they outbid an earlier bid in one of several ways. For example, a subsequent bid needs to outbid an earlier bid in at least one bidding item, or subsequent bids need to outbid a previous bid in all bidding items, or subsequent bids need to outbid a previous bid in at least a certain number of bid items such as described above. If it is determined that the bid is not a valid bid at decision state 1110, process 740 proceeds to a state 1112, considers the bid to be invalid and displays valid bid rules and values for the banker or lender. Process 740 then moves back to state 1108 to obtain a new bid from the banker or lender. If the bid was determined to be a valid bid at decision state 1110, process 740 then proceeds to a decision state 1114 to determine if the bid included attached conditions. These conditions include certain documentation or finding conditions that the banker or lender wants satisfied before continuing with the bid as previously described above. If it is determined that conditions are attached at decision state 1114, process 740 proceeds to state 1116 to set the bid with an inactive status. Moving back to state 1104, the starting bid item values are maintained from the previous instance at state 1104 for a subsequent bid. Returning to decision state 1114, if it is determined that conditions are not attached with the bid, process 740 proceeds to state 1118, updates the bid item values with the new values from the current banker bid and sets the bid status to be active. Moving back to state 1104, these new bid item values are used to set new starting bid item values at state 1104 for a subsequent bid.

Returning to decision state 1106, if it is determined that the current time is equal or greater than the auction end time T, process 740 proceeds to state 1120 to get the last valid and active bid made by one of the registered bankers or lenders. Proceeding to decision state 1122, if a valid and active bid was found during the current auction, process 740 proceeds to state 1124 to end the auction and the banker or lender with the last valid and active bid value is the winner. Process 740 then advances to state 1126 to register the auction result, such as via the transaction component 45 (FIG. 4), and stores the auction results in the primary loan bid database 44 (FIG. 4). The primary loan auction process 740 then completes. Returning to decision state 1122, if it is determined that a valid and active bid was not found, process 740 proceeds to state 1130 where the auction is ended without a winner. Advancing to a decision state 1132, process 740 determines whether the auction should be re-listed for a subsequent auction. If so, process 740 moves back to state 1104 to restart the auction. In one embodiment, the auction would be restarted with new starting bid item values. If at decision state 1132, it is determined that the auction should not be re-listed, process 740 proceeds to state 1126 to register the auction results and store the results in primary loan bid database 44.

Referring now to FIG. 12, the primary loan sub-auction process appraisal 734, previously described in conjunction with FIG. 7, will now be described. Registered appraiser agents 118 interface through Internet 130 or other network with the primary loan system portion of the overall system. Prior to the beginning of the sub-auction process 734, a starting bid amount of X dollars, a minimum bidding decrement value of A dollars and an auction end time of T are established. Process 734 starts the appraisal auction at state 1202 and proceeds to state 1204 to set the bid amount to start for the appraisal cost to be X dollars. Proceeding to a decision state 1206, process 734 determines if the current time is less than the auction end time T. If the current time is less than the auction end time, process 734 advances to state 1208 to obtain a bid from the appraisal agent of Y dollars. Continuing at a decision state 1210, process 734 determines if the bid is a valid bid, that is, if the value of A is less than or equal to the starting bid amount minus the minimum bidding decrement value of A. If it is determined that the bid is not a valid bid at decision state 1210, process 734 moves to state 1212 to identify the bid as being invalid and display a minimum valid bid amount to the appraisal agent bidding. Process 734 then moves back to state 1208 to get a new bid from the appraisal agent. However, if it is determined that the bid is a valid bid, as determined at decision state 1210, process 734 continues at a decision state 1214 to determine if conditions are attached with the bid. If not, process 734 proceeds to state 1216 and sets the bid to have an active status. However, if conditions are attached with the current bid, as determined at decision state 1214, process 734 then proceeds to state 1218 where the bid is given an inactive status. At completion of state 1216, process 734 advances to state 1220 to set the current bid value of Y to be the new X and then moves back to state 1204 to use the new value of X as the new starting bid amount for a subsequent pass through the auction. If the current bid is an inactive status bid, process 734 bypasses state 1220 and maintains the current value of X to be used at state 1204 for a subsequent bid.

Returning to decision state 1206, if it is determined that the current time is equal to or greater than the auction end time T, then process 734 proceeds to state 1230. At state 1230, process 734 gets the last valid and active bid received prior to the end of the auction time T. Proceeding to a decision state 1232, process 734 determines if a valid and active bid was found. If so, process 734 advances to state 1234 to end the auction and declare that the appraiser agent with the last valid bid is the winner of this auction. Process 734 then advances to state 1236 to register the auction result such as via transaction component 45 (FIG. 4) and store the results in the primary loan bid database 44. Sub-auction process 734 then completes. Returning to decision state 1232, if it is determined that a valid and active bid is not found, process 734 proceeds to state 1240 to end the auction without a winner. Advancing to a decision state 1242, process 734 determines whether the auction should be re-listed. If so, process 734 moves back to state 1204 to re-list the auction. In one embodiment, the minimum starting bid amount of X could be set to a different value and/or a minimum bidding decrement value of A could be set to a different value prior to starting the new auction. If the auction is not to be re-listed, as determined at decision state 1242, process 734 moves to state 1236 to register the auction results and store the results in the primary loan bid database 44.

Referring to FIG. 13, the primary loan sub-auction process—hazard insurance policy 736, previously described in conjunction with FIG. 7, will now be described. The sub-auction process 736 is very similar to the sub-auction process—appraisal 734 with the following exceptions. The bidders in this auction are registered insurance providers or agents rather than the registered appraiser agents in process 734. At state 1302, the auction is started for the homeowners hazard insurance policy. For certain types of real estate, the insurance policy can be a homeowners association (HOA) policy. At state 1304, the (starting) bid amount of X dollars is for a cost of a homeowners hazard insurance policy. At state 1308, the bid is obtained from the registered insurance provider or agent. At state 1334, the winner is the insurance agent or provider with the last valid bid.

Referring to FIG. 14, the primary loan sub-auction process—title 738 will now be described. Sub-auction process 738 is similar to sub-auction process for appraisal 734 with the following exceptions. The bidders in the title sub-auction are registered title policy providers or agents rather than the registered appraiser agents in process 734. At state 1402, the auction that is started is the title auction. At state 1404, the (starting) bid amount of X dollars is for the cost of the title policy. At state 1408, the bid is obtained from a title agent. At state 1434, the title agent or provider with the last valid bid is the winner.

Referring to FIG. 15, the primary loan sub-auction process—notary 744, previously described in conjunction with FIG. 7, will now be described. The sub-auction process for notary 744 is very similar to the sub-auction process for appraisal 734 with the following exceptions. The bidders in the process for notary 744 are registered notary agents rather than the registered appraiser agents in process 734. At state 1502, the auction that is started is the notary auction. At state 1504, the (starting) bid amount value of X is for a notary cost. At state 1508, the bid is obtained from a notary agent. At state 1534, the notary agent with the last valid bid is designated the winner.

Referring to FIG. 16, the secondary loan creation process 750, previously described in conjunction with FIG. 7, will now be described. Registered brokers 116, registered mortgage bankers 122 and third party services providers 118 such as escrow agents, title appraisers and so forth communicate via the Internet 130 or other type of network with the secondary loan system portion of the overall system. The secondary loan system portion of the system is shown in the lower portion of FIG. 1. The process 750 obtains a primary loan package from the primary loan auction engine 100 (FIG. 1) or via other ways. In one embodiment, a mini-application from the lead auction engine 50 can be used as a starting point for obtaining the necessary loan package information. In other embodiments, other written or on-line forms can be used to obtain the necessary information. Proceeding to a state 1604, process 750 obtains uploaded additional scanned loan documents as necessary for the secondary market. In one embodiment, these scanned loan documents are obtained via component 250, the secondary loan uploader engine shown in FIGS. 1 and 5. Advancing to a decision state 1606, process 750 determines if the secondary loan package is complete. In one embodiment, process 750 uses the secondary loan processing component 155 (FIG. 5) to make this determination. If it is determined that the secondary loan package is not complete, process 750 moves back to state 1604 to obtain additional scanned loan documents as necessary. However, if it is determined that the secondary loan package is complete at decision state 1606, process 750 advances to an optional state 1608 to pool multiple secondary loan packages together for a single auction. This pooling is typically done for most auctions, but single secondary loans can be auctioned also. Proceeding to a state 1610, process 750 fine tunes the wish list item of a mortgage banker rebate value. In one embodiment, the secondary visual help component 205 (FIG. 5) is used to help with the fine tuning of the wish list item of the banker rebate value. Moving to a state 1612, process 750 registers the final rebate value as the bidding item. Continuing at a state 1614, process 750 has the secondary loan package for the secondary loan auction signed off by the mortgage banker. The secondary loan package information is stored in the secondary loan database 165 (FIG. 6) and the process 750 completes.

Referring to FIG. 17, the secondary loan auction process 760, previously described in conjunction with FIG. 7, will now be described. Registered investors 126 communicate via the Internet 130 or other network to the secondary loan system portion of the overall system. Prior to the start of the secondary loan auction process 760, a starting bid amount value of X dollars, a minimum bidding increment value of A dollars, and an auction end time of T are established. The process 760 starts the secondary loan auction at state 1702 and advances to state 1704 to set a minimum bid amount value of X for the banker's rebate value. Proceeding to a decision state 1706, process 760 determines if the current time is less than the auction end time T. If so, process 760 proceeds to state 1708 to obtain a bid from the investor, being the bidder in this auction, of Y dollars. Advancing to a decision state 1710, a determination is made whether the bid is a valid bid, that is, is Y greater or equal to the starting bid amount plus a minimum bidding increment value of A. If it is determined that the bid is not a valid bid, process 760 moves to a state 1712 where the bid is labeled as an invalid bid and the minimum valid bid amount is displayed to the bidder. Process 760 then moves back to state 1708 to obtain a new bid from the investor. However, if it is determined that a valid bid was received as determined at decision state 1710, process 760 then proceeds to a decision state 1714. At decision state 1714, it is determined whether conditions are attached to the bid. If there are no conditions attached to the bid, process 760 advances to state 1716 to set the status of the bid as an active bid. However, if conditions are attached to the bid, as determined at decision state 1714, process 760 proceeds to state 1718 to set the status of the bid as an inactive bid. At the completion of state 1716, process 760 moves to state 1720 to set the value of Y to be the new value of X. Process 760 then moves back to state 1704 to use the new value of X as the minimum bid amount of the banker's rebate value for a subsequent pass (bid) through the auction. If the current bid is an inactive status bid, process 760 bypasses state 1720 and maintains the current value of X to be used at state 1704 for a subsequent bid.

Returning to decision state 1706, if it is determined that the current time is equal to or greater than the auction end time T, process 760 proceeds to state 1730 to get the last valid and active bid. Moving to decision state 1732, process 760 determines if a valid and active bid was found. If so, process 760 advances to state 1734 to end the auction and declare the investor with the last valid bid as the winner. Process 760 continues at state 1736 to register the auction result, such as via transaction component 45 (FIG. 6). The results are stored in the secondary loan bid database 170 and secondary loan auction process 760 completes. Returning to decision state 1732, if it is determined that a valid and active bid is not found, process 760 advances to state 1740 and ends the auction without a winner. Proceeding to a decision state 1742, process 760 determines if the secondary loan auction should be re-listed. If so, process 760 moves back to state 1704 to re-list the auction. In one embodiment, the minimum bid amount value of X and/or the minimum bidding increment value of X can be set to different values for a subsequent auction. However, if the auction is not to be re-listed, as determined at decision state 1742, process 760 proceeds to state 1736 to register the auction result and store the result in secondary loan bid database 170 (FIG. 6).

As previously described, there are sub-auctions of additional items associated with the primary loan package. These are:
a. Homeowners/Hazard Insurance
b. Title Insurance
c. Appraisals
d. Notary

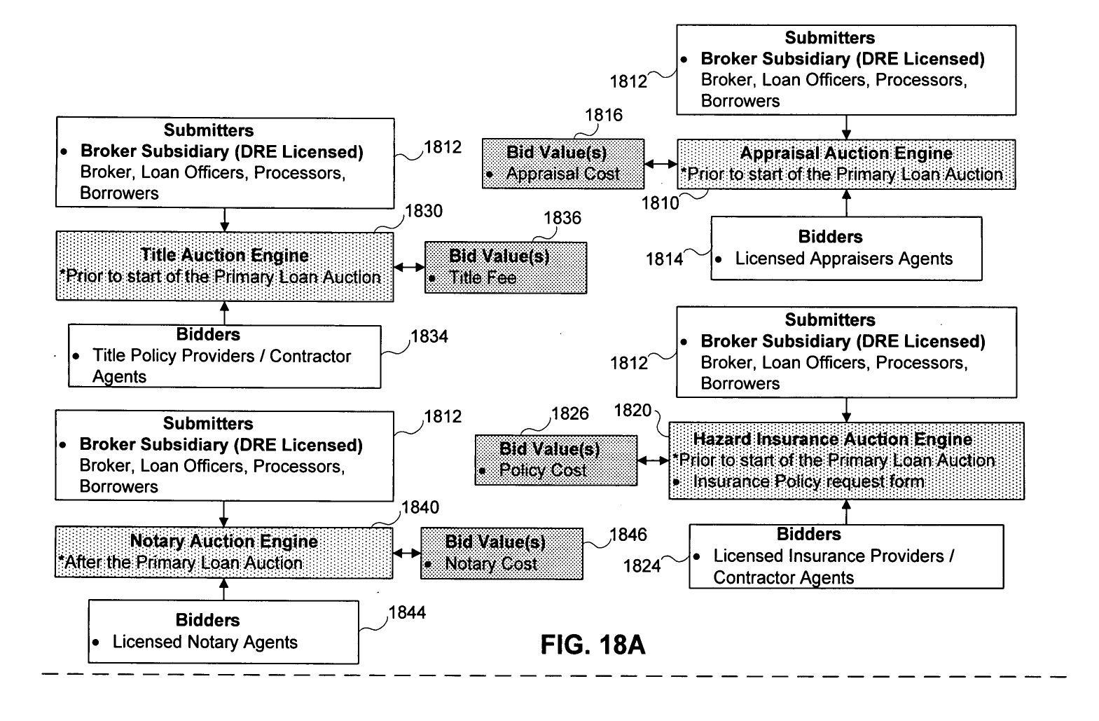

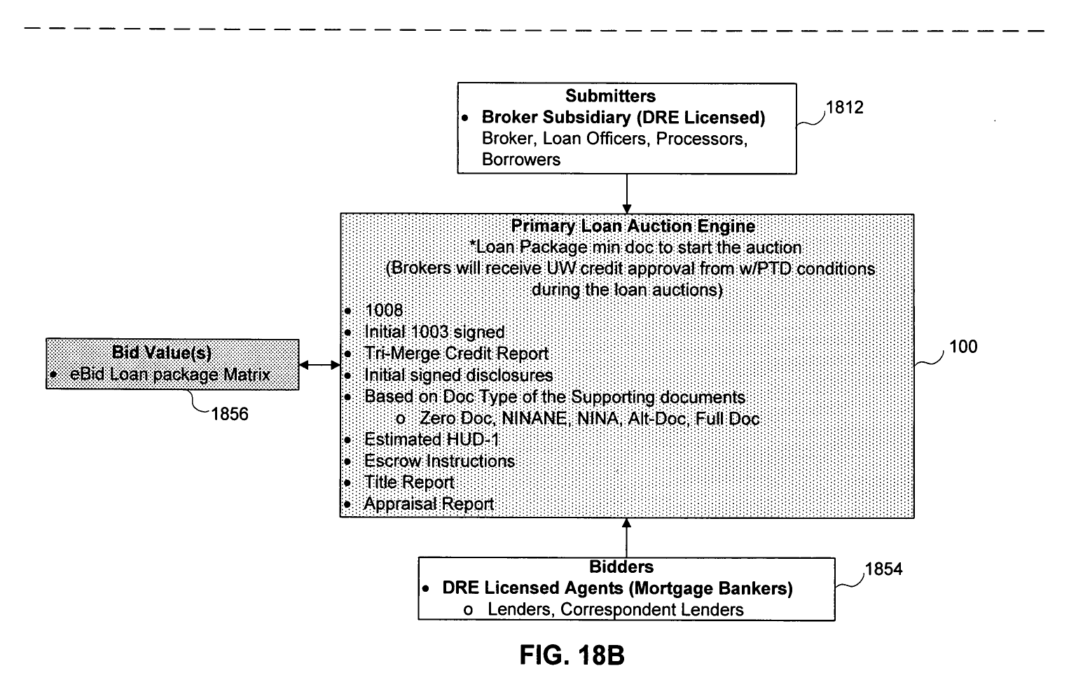

Referring to FIGS. 18A and 18B, the previously described sub-auction engines will now be discussed. In one embodiment, subsidiary submitters 1812 (Department of Real Estate (DRE) licensed) including broker, loan officers, processors, borrowers, submit a loan package to the primary loan auction engine 100. The loan package includes a minimum amount of documentation to start the auction. Brokers will receive underwritable credit approval with PTD conditions during the loan actions. In certain embodiments the loan package includes documents as follows: a 1008 form, an initial 1003 signed form, a Tri-Merge Credit Report, initial signed disclosures, based on documentation type of the supporting documents (Zero Doc, No Income/No Asset/No Employment (NINANE), No Income/No Asset (NINA), Alt-Doc, Full Doc), estimated HUD-1, escrow instructions, title report and appraisal report. Bidders 1854 can include DRE licensed agents (mortgage bankers) that can be lenders or correspondent lenders. An output of the primary loan auction engine 100 is a set of one or more bid values 1856 including a loan package matrix.

The submitters 1812 perform the following acts:
Submit a Loan package to the primary loan auction engine 100 just as an outside broker would.
Submit Title Policy leads to the title auction engine 1830 for bidding (Title providers 1834 compete to offer lowest Title fee 1836 to the borrower)
Submit Appraisal leads to the appraisal auction engine 1810 for bidding (Appraisal agents 1814 compete to offer lowest appraisal fee 1816 and fastest turnaround to the borrower)
Submit Homeowners/Hazard Insurance Policy leads to the insurance auction engine 1820 for bidding (Insurance Policy providers 1824 compete to offer lowest Policy and premium cost 1826 to the borrower)
Charge fee for Loan Origination, administration fees, processing fees similar to outside broker members and in compliance with all and each States DRE regulations
Submit Notary leads to the notary auction engine 1840 for bidding (Notary agents 1844 compete to offer lowest Notary fee 1846, most convenient and fastest turnaround to the borrower)

The service entity maintaining the electronic bidding system may or may not charge any auction fees for auction of the Title, Appraisal, and Hazard transactions. Thus, the service entity may charge periodic advertising and/or membership fees to compensate for the auction services to either the bidders or submitters members or both.

Notary fees may be charged under the broker subsidiary invoice as part of the Good Faith Estimate (GFE) or HUD-1 cost and/or under the service entity.com advertising cost to the notary agents, whichever has no restriction. The service entity is the auction service provider while the broker subsidiary is the decision maker or submitter of the notary auction when the loan is ready to be documented and notarized.

In other embodiments, the submitters 1812 are DRE licensed agents (broker or sales person) including brokers, loan officers, realtors and processors.

The interaction of lead auction engine, primary loan auction engine and the secondary loan auction engine brings all sorts of real estate entities online to a common marketplace to facilitate their business. Borrower, processor (broker organization), loan agent (broker organization), account executive (Lender Organization), assistant account manager (Lender Organization), underwriter (Lender Organization), account manager/Broker Coordinator (Lender Organization), document drawer (Lender Organization), funder (Lender Organization), shipper (Lender Organization), investor, realtor (both buying and listing agents) and many more will use the system to interact in the online common market place. All these entities together are called an E-Mortgage-Community. Since the electronic bidding system brings all these entities together, it provides a search engine that allows any member to search for information relevant to its own business in the E-Mortgage-Community.

An additional engine, a Mortgage Search Engine, is an exclusive search engine, specifically designed to cater to the needs of mortgage industry. Every possible member of the electronic bidding system is profiled in the system in such a way that any other entity looking for certain relevant information is able to gather it through the search engine. Members are provided with the option to fine-tune the information they would like to keep in the profile of search engine. For example a processor looking for a job can potentially search for all the brokers members of the system. The search would do an intelligent match of processor's advertised talent and broker's requirement and come up with matching broker names. Possible members of the electronic bidding system along with what the member can post and what can be searched is provided in Table 4.

TABLE 4
eCommunity Members

A Processor can post their resume for Employers to view and search
for employment.
A contractor/consultant process can post their business credentials for
Brokers, Lenders to view and search for available loans to be processed posted by the
brokers & Lenders.
An account manager/broker coordinator can post their resumes for
Lenders to view and search for available employments posted by the Lenders.
An underwriter can post their resumes for Lenders to view and search
for available employments posted by the Lenders.
A contractor/consultant underwriting can post their business
credentials for Lenders to view and search for available underwriting transactions posted
by the Lenders.
A doc drawer can post their resumes for Lenders to view and search
for available employments posted by the Lenders.
A contractor/consultant doc drawer can post their business credentials
for Lenders to view and search for available contractor/consultant doc drawer
transactions posted by the Lenders.
A funder can post their resumes for Lenders to view and search for
available employments posted by the Lenders.
A contractor/consultant funder can post their business credentials for
Lenders to view and search for available contractor/consultant funding transactions
posted by the Lenders.
A shipper can post their resumes for Lenders to view and search for
available employments posted by the Lenders.
A contractor/consultant shipper can post their business credentials for
Lenders to view and search for available contractor/consultant shipper transactions posted
by the Lenders.
Secondary marketing can post their resumes for Lenders to view and
search for available employments posted by the Lenders.
A contractor/consultant secondary marketing can post their business
credentials for Lenders to view and search for available secondary marketing
contractor/consulting transactions posted by the Lenders.
A realtor: listing-agent can post their business credentials for sellers to
view, post their property listings for buyers and buyers agents to view and search for
WTB home not listed in MLS but in our engine.
A seller: for sale by owner can post their property listings for buyers
and buyers agents to view and eliminate the listing agent and costs associated with that
and search for WTB home posted by the buyers or buyers' agents, which has not been
listed in MLS.
A realtor: buyers-agent can post their WTB properties for sellers or
listing agents to view, which may have not been listed in the MLS but is a for sale by
owner property without listing agents and search for available properties listed by the
seller-for sale by owner or listing agents.
An escrow company can post their business credentials for Brokers,
Lenders, Title, Banks, Realtors to view and search for escrow transactions requirements
posted by the Brokers, Lenders, Title, Banks, Realtors, etc.
A title company can post their business credentials for Brokers,
Lenders, Escrow, Banks, Realtors to view and search for title transactions requirements
posted by the Brokers, Lenders, Escrow, Banks, Realtors, etc.
A document delivery company can post their business credentials for
Brokers, Lenders, Escrow, Title, Banks, Realtors to view and search for document
delivery requirements posted by the Brokers, Lenders, Escrow, Title, Banks, Realtors and
etc.
A doc imaging company can post their business credentials for
Brokers, Lenders, Escrow, Title, Banks, Realtors to view and search for document
imaging requirements posted by the Brokers, Lenders, Escrow, Title, Banks, Realtors,
etc.
A data warehousing/imaging company can post their business
credentials for Brokers, Lenders, Escrow, Title, Banks, Realtors to view and search for
document data warehousing/imaging requirements posted by the Brokers, Lenders,
Escrow, Title, Banks, Realtors, etc.
A builders/developers company can post their new build property
listing and business credentials for Brokers, Lenders, Escrow, Title, Banks, Realtors to
view and search for WTB new build home requirements posted by the Brokers, Buyers,
Lenders, Realtors, etc.
Building contractors can post their business credentials for
Builders/Developers, Realtors to view and search for new property building contractor
requirements posted by the Builders/Developers, Realtors and etc.
Notary agents can post their business credentials for Brokers, Lenders,
Escrow, Title, Banks, And Realtors to view and search for document notary requirements
posted by the Brokers, Lenders, Escrow, Title, Banks, and Realtors, etc.
Appraiser agents can post their business credentials for Brokers,
Lenders, Realtors and others to view and search for property appraisal requirements
posted by the Brokers, Lenders, Realtors and others.
Numerous modifications and changes will readily occur to those
skilled in the art. It is not desired to limit the embodiments to the exact construction and
operation shown and described, and accordingly, all suitable modifications and
equivalents may be resorted to, falling within the scope of the embodiments.

1. An electronic marketplace method for loans, the method comprising:
receiving, via an electronic interface, mortgage loan information, the loan information comprising social security information;
retrieving credit information using, at least in part, the social security information;
generating a credit score based upon the retrieved credit information;
transmitting, via an electronic interface, the generated credit score to a plurality of brokers;
auctioning to the brokers, via an electronic interface, access to the received mortgage loan information;
wherein the auctioning to the brokers comprises:
setting an initial value for a broker bid and a bid increment;
automatically receiving bids from the plurality of brokers; and
automatically determining one of the bids based upon auction criteria and the broker bid value;
setting an initial value for a service provider bid item based on, at least in part, the loan information;
receiving bids from a plurality of service providers in conjunction with a loan;
automatically determining one of the service provider bids based upon auction criteria and the service provider bid item;
identifying at least one borrowing criteria based on an underwritable loan package;
automatically receiving bids from a plurality of mortgage bankers;
automatically determining one of the bids based upon auction criteria and the borrowing criteria;
receiving one or more secondary underwritten loan packages associated with a banker, the secondary loan packages identifying a secondary loan bid item;
setting an initial value for the secondary loan bid item based on the secondary loan packages;
automatically receiving bids from a plurality of investors; and
automatically determining one of the investor bids based upon auction criteria and the secondary loan bid item.

2. The method defined in claim 1, wherein the auctioning comprises auctioning access to the mortgage loan information of one prospective borrower.

3. The method of claim 1, wherein the auction criteria comprise improving on a valid bid.

4. The method of claim 1, wherein the auction criteria comprise a bid received before an auction end time.

5. The method of claim 1, wherein the service provider bid item comprises an appraisal and an associated cost of the appraisal.

6. The method of claim 1, wherein the service provider bid item comprises a homeowners insurance policy and an associated cost of the insurance policy.

7. The method of claim 1, wherein service provider the bid item comprises a title policy and an associated cost of the title policy.

8. The method of claim 1, wherein the service provider bid item comprises notary service and an associated cost of the notary service.

9. The method of claim 1, wherein the borrowing criteria comprise a predetermined minimum number of criteria.

10. The method of claim 1, wherein the borrowing criteria are entered by the borrower or a broker for the borrower.

11. The method of claim 1, wherein the mortgage bankers do not have access to selected personal information about the borrower until reaching a bidding level.

12. The method of claim 1, wherein the borrowing criteria comprises a desired interest rate for the loan.

13. The method of claim 1, wherein the borrowing criteria comprises a prepayment penalty term for the loan.

14. The method of claim 1, wherein the borrowing criteria comprises a desired closing cost percentage for the loan.

15. The method of claim 1, wherein the borrowing criteria comprises a loan program period for the loan.

16. The method of claim 1, wherein the borrowing criteria comprises a desired loan term for the loan.

17. The method of claim 1, wherein the borrowing criteria comprises a desired broker rebate for the loan.

18. The method of claim 1, wherein the secondary loan bid item comprises a banker rebate and a value of the rebate.

19. In an apparatus for facilitating issuance of mortgage loans, comprising the computer implemented acts of:
storing a plurality of bid items;
comparing the stored bid items with bids received from mortgage bankers;
automatically determining one of the bids based upon auction criteria and the bid items, wherein the auction criteria comprise improving on a valid bid, wherein the valid bid improves on a predetermined number of bid items of a last valid bid by at least a guideline value, and wherein the auction criteria comprise a lack of banker conditions for the loan;
receiving one or more secondary underwritten loan packages associated with a banker, the secondary underwritten loan packages identifying a secondary loan bid item;
storing an initial value for the secondary loan bid item based on the secondary underwritten loan packages;
comparing the stored secondary loan bid item value with bids received from investors; and
automatically determining one of the bids based upon secondary loan auction criteria and the secondary loan bid item, wherein the secondary loan auction criteria comprise improving on a valid bid, wherein the valid bid improves on a last valid bid by at least a guideline value, and wherein the secondary loan auction criteria comprise a lack of investor conditions for the loan.

20. The method of claim 19, wherein the secondary loan bid item comprises a banker rebate and a value of the rebate.

21. The method of claim 19, wherein the auction criteria comprise a valid bid received before an auction end time.

22. In an apparatus for facilitating issuance of mortgage loans, comprising the computer implemented acts of:
storing a plurality of bid items;
comparing the stored bid items with bids received from mortgage bankers; and
automatically determining one of the bids based upon auction criteria and the bid items, wherein the auction criteria comprise improving on a valid bid, wherein the valid bid improves on a predetermined number of bid items of a last valid bid by at least a guideline value, and wherein the auction criteria comprise a lack of banker conditions for the loan.

23. A computerized method comprising:
receiving, via an electronic interface, mortgage loan information about a plurality of prospective borrowers, the loan information comprising social security information; retrieving credit information using, at least in part, the social security information;
generating a credit score based upon the retrieved credit information;
transmitting, via an electronic interface, the generated credit score to a plurality of bidders; and
auctioning to the bidders, via an electronic interface, access to the received mortgage loan information.

24. The method defined in claim 23, wherein the auctioning comprises auctioning access to the mortgage loan information of one prospective borrower.

25. The method defined in claim 23, wherein the bidders comprise brokers.

26. The method defined in claim 23, additionally comprising:
receiving, via an electronic interface, mortgage loan information about a plurality of prospective borrowers, the loan information without social security information; and
selling, via an electronic interface, access to the received mortgage loan information without the social security information.

27. The method defined in claim 26, wherein the selling comprises bundling mortgage loan information from a plurality of prospective borrowers for sale to a broker.

28. A computerized method comprising:
receiving, via an electronic interface, mortgage loan information from a plurality of prospective borrowers;
selecting mortgage loan information not having social security information; and
selling, via an electronic interface, access to the selected mortgage loan information.

29. A computerized method comprising:
receiving an underwritable loan package, the underwritable loan package identifying at least one borrowing criteria;
automatically receiving bids from a plurality of mortgage bankers; and
automatically determining one of the bids based upon auction criteria and the borrowing criteria.

30. The method of claim 29, wherein the borrowing criteria comprise a predetermined minimum number of criteria.

31. The method of claim 29, wherein the borrowing criteria are entered by the borrower or a broker for the borrower.

32. The method of claim 29, wherein the mortgage bankers do not have access to selected personal information about the borrower until reaching a bidding level.

33. The method of claim 29, wherein the mortgage bankers must place a bid upon accessing a complete underwritable loan package of the borrower.

34. The method of claim 33, wherein the mortgage bankers place a bid with either certain documentation or funding conditions or with no conditions.

35. The method of claim 29, wherein the auction criteria comprises a timeframe for accepting bids.

36. The method of claim 34, wherein the auction criteria comprises a bid without documentation or funding conditions.

37. The method of claim 36, wherein the auction criteria further comprises a bid received before an auction end time.

38. The method of claim 29, wherein the borrowing criteria comprises a desired interest rate for the loan.

39. The method of claim 29, wherein the borrowing criteria comprises a prepayment penalty term for the loan.

40. The method of claim 29, wherein the borrowing criteria comprises a desired closing cost percentage for the loan.

41. The method of claim 29, wherein the borrowing criteria comprises a loan program period for the loan.

42. The method of claim 29, wherein the borrowing criteria comprises a desired loan term for the loan.

43. The method of claim 29, wherein the borrowing criteria comprises a desired broker rebate for the loan.

44. A computerized system comprising:
means for receiving an underwritable loan package, the underwritable loan package identifying at least one borrowing criteria,
means for automatically receiving bids from a plurality of mortgage bankers; and
means for automatically determining one of the bids based upon auction criteria and the borrowing criteria.

45. A computer readable medium containing software that, when executed, causes the computer to perform the acts of:
receiving an underwritable loan package, the underwritable loan package identifying at least one borrowing criteria;
automatically receiving bids from a plurality of mortgage bankers; and
automatically determining one of the bids based upon auction criteria and the borrowing criteria.

46. A computerized method comprising:
receiving an underwritable loan package, the underwritable loan package identifying at least one borrowing criteria;
automatically receiving bids from a plurality of mortgage bankers; and
automatically determining one of the bids based upon auction criteria and the borrowing criteria, wherein the bids include certain documentation or funding conditions or no banker conditions.

47. The method of claim 46, further comprising treating a bid with documentation or funding conditions as an inactive bid.

48. The method of claim 46, further comprising treating a bid with no conditions as an active bid.

49. The method of claim 48, wherein the auction criteria for selecting a bid comprises a bid status being active.

50. A method comprising:
receiving loan information about a borrower, the loan information including at least a unique identifier corresponding to the borrower;
setting an initial value for a bid and a bid increment;
automatically receiving bids from a plurality of mortgage brokers; and
automatically determining one of the bids based upon auction criteria and the bid value.

51. The method of claim 50, wherein the auction criteria comprise improving on a valid bid.

52. The method of claim 51, wherein a valid bid improves on a last valid bid by at least the bid increment.

53. The method of claim 50, wherein the auction criteria comprise a bid received before an auction end time.

54. The method of claim 52, wherein the auction criteria comprise a valid bid received before an auction end time.

55. The method of claim 50, wherein the unique identifier corresponding to the borrower comprises a social security number.

56. The method of claim 50, wherein the unique identifier corresponding to the borrower comprises a nationally recognized identification number.

57. A method comprising:
receiving an underwritable loan package, the underwritable loan package identifying at least one bid item;
setting an initial value for each bid item based on the underwritable loan package;
automatically receiving bids from a plurality of mortgage bankers; and
automatically determining one of the bids based upon auction criteria and the bid items.

58. The method of claim 57, wherein the underwritable loan package is received from a broker.

59. The method of claim 57, wherein the bid items comprise a predetermined minimum number of items.

60. The method of claim 57, wherein the bid items are entered by the borrower or a broker for the borrower.

61. The method of claim 57, wherein the bid items are entered by the borrower and a broker for the borrower collaborating together.

62. The method of claim 57, wherein the bid items comprise an item type and an item value.

63. The method of claim 57, wherein the auction criteria comprise improving on a valid bid.

64. The method of claim 63, wherein the valid bid improves on at least one bid item of a last valid bid by at least a guideline value.

65. The method of claim 57, wherein the auction criteria comprise improving on a valid bid for a predetermined number of bid items.

66. The method of claim 57, wherein the auction criteria comprise a lack of banker conditions for the loan.

67. The method of claim 57, wherein the auction criteria comprise one or more banker documentation or funding conditions for the loan that are met by the borrower or a broker for the borrower.

68. The method of claim 57, wherein the auction criteria comprise a bid received before an auction end time.

69. The method of claim 64, wherein the auction criteria comprise a valid bid with a lack of banker conditions for the loan, the bid received before an auction end time.

70. A computerized system comprising:
means for receiving an underwritable loan package, the underwritable loan package identifying at least one bid item;
means for setting an initial value for each bid item based on the underwritable loan package;
means for automatically receiving bids from a plurality of mortgage bankers; and
means for automatically determining one of the bids based upon auction criteria and the bid items.

71. A computer readable medium containing software that, when executed, causes the computer to perform the acts of:
receiving an underwritable loan package, the underwritable loan package identifying at least one bid item;
setting an initial value for each bid item based on the underwritable loan package;
automatically receiving bids from a plurality of mortgage bankers; and
automatically determining one of the bids based upon auction criteria and the bid items.

72. A computerized method comprising:
receiving one or more secondary underwritten loan packages associated with a banker, the secondary underwritten loan packages identifying a bid item;
setting an initial value for the bid item based on the secondary underwritten loan packages;
automatically receiving bids from a plurality of investors; and
automatically determining one of the bids based upon auction criteria and the bid item.

73. The method of claim 72, wherein the bid item comprises a banker rebate and a value of the rebate.

74. The method of claim 72, wherein the auction criteria comprise improving on a valid bid.

75. The method of claim 74, wherein a valid bid improves on a last valid bid by at least a guideline value.

76. The method of claim 72, wherein the auction criteria comprise a lack of investor conditions for the loan.

77. The method of claim 72, wherein the auction criteria comprise one or more investor documentation or funding conditions for the loan that are met by the banker.

78. The method of claim 72, wherein the auction criteria comprise a bid received before an auction end time.

79. The method of claim 75, wherein the auction criteria comprise a valid bid with a lack of investor conditions for the loan, the bid received before an auction end time.

80. A computerized system comprising:
means for receiving one or more secondary underwritten loan packages associated with a banker, the secondary underwritten loan packages identifying a bid item;
means for setting an initial value for the bid item based on the secondary underwritten loan packages;
means for automatically receiving bids from a plurality of investors; and
means for automatically determining one of the bids based upon auction criteria and the bid item.

81. A computer readable medium containing software that, when executed, causes the computer to perform the acts of:
receiving one or more secondary underwritten loan packages associated with a banker, the secondary underwritten loan packages identifying a bid item;
setting an initial value for the bid item based on the secondary underwritten loan packages;
automatically receiving bids from a plurality of investors; and
automatically determining one of the bids based upon auction criteria and the bid item.

82. A method comprising:
receiving loan information about a borrower;
setting an initial value for a bid item based on, at least in part, the loan information;
automatically receiving bids from a plurality of service providers in conjunction with a loan; and
automatically determining one of the bids based upon auction criteria and the bid item.

83. The method of claim 82, wherein the bid item comprises an appraisal and an associated cost of the appraisal.

84. The method of claim 82, wherein the bid item comprises a homeowners insurance policy and an associated cost of the insurance policy.

85. The method of claim 84, wherein the homeowners insurance policy comprises a homeowners association policy or a hazard policy.

86. The method of claim 82, wherein the bid item comprises a title policy and an associated cost of the title policy.

87. The method of claim 82, wherein the bid item comprises notary service and an associated cost of the notary service.

88. The method of claim 82, wherein the auction criteria comprise improving on a valid bid.

89. The method of claim 88, wherein a valid bid improves on a last valid bid by at least a decrement value.

90. The method of claim 82, wherein the auction criteria comprise a lack of provider conditions for the loan.

91. The method of claim 82, wherein the auction criteria comprise one or more provider conditions for the service that are met by the borrower or a broker for the borrower.

92. The method of claim 82, wherein the auction criteria comprise a bid received before an auction end time.

93. The method of claim 89, wherein the auction criteria comprise a valid bid with a lack of provider conditions for the loan, the bid received before an auction end time.

94. A computerized method comprising:
electronically tracking a receipt of each of a plurality of documents in an underwritable loan package in preparation of an electronic auction; and
electronically displaying a status to a broker, the status identifying which of the plurality of documents have been received and which of the documents are missing from the loan package.

95. The method of claim 94, additionally comprising receiving a scanned image of at least one of the plurality of documents.

96. The method of claim 94, additionally comprising receiving a facsimile of at least one of the plurality of documents.

97. The method of claim 94, additionally comprising physically receiving at least one of the plurality of documents.

98. The method of claim 94, wherein the status for each of the plurality of documents comprises complete, in process, or pending.

99. The method of claim 94, additionally comprising displaying the plurality of documents via a network browser.

100. The method of claim 94, wherein the plurality of documents comprises a 1003 loan application, a 1008 summary of loan application, and a credit report.
